(19) United States
(12) Patent Application Publication
(10) Pub. No.: US 2018/0054798 A1
(43) Pub. Date: Feb. 22, 2018

(54) APPARATUS, SYSTEM AND METHOD OF COMMUNICATING IN A DATA GROUP

(71) Applicant: INTEL IP CORPORATION, SANTA CLARA, CA (US)

(72) Inventors: Dibakar Das, Troy, NY (US); Minyoung Park, Portland, OR (US); Po-Kai Huang, San Jose, CA (US); Emily H. Qi, Gig Harbor, WA (US); Elad Oren, Tel Aviv (IL)

(21) Appl. No.: 15/559,589

(22) PCT Filed: Apr. 20, 2016
(86) PCT No.: PCT/US2016/028337

§ 371 Date: Sep. 19, 2017

Related U.S. Application Data
(60) Provisional application No. 62/150,395, filed on Apr. 21, 2015.
(60) Provisional application No. 62/149,726, filed on Apr. 20, 2015.

(51) Int. Cl. H04W 68/02; H04W 74/00; H04W 4/08; H04W 8/00; H04L 29/06

(52) U.S. Cl. CPC H04W 68/02; H04W 74/006; H04L 65/4076; H04W 8/005; H04W 4/08

(57) ABSTRACT

Some demonstrative embodiments include apparatuses, systems and/or methods of communicating in a data group. For example, an apparatus may include logic and circuitry configured to cause Neighbor Awareness Networking (NAN) device to generate a paging message including one or more list elements corresponding to one or more class types, a list element corresponding to a class type to indicate one or more devices of a data group for which data of the class type is pending transmission; to transmit the paging message during a Negotiation time (NT) in a timeblock of the data group; to process a trigger message from a paged device of the data group during a Data Transmission Time (DTxT) following the NT; and, based on the trigger message, to transmit data to the paged device during the DTxT.

### CROSS REFERENCE

This application claims the benefit of and priority from U.S. Provisional Patent Application No. 62/149,726 entitled “APPARATUS, SYSTEM AND METHOD OF COMMUNICATING WITHIN A DATA GROUP”, filed Apr. 20, 2015, and from U.S. Provisional Patent Application No. 62/150,395 entitled “APPARATUS, SYSTEM AND METHOD OF COMMUNICATING WITHIN A DATA GROUP” filed Apr. 21, 2015, the entire disclosures of both of which are incorporated herein by reference.

### TECHNICAL FIELD

Embodiments described herein generally relate to communicating in a data group.

### BACKGROUND

Neighbor awareness networking, for example, according to a Wireless Fidelity (Wi-Fi) Aware Specification, may enable wireless devices, for example, Wi-Fi devices, to perform device/service discovery, e.g., in their close proximity.

The neighbor awareness networking may include forming a cluster, e.g., a Wi-Fi Aware cluster, for devices in proximity Devices in the same Wi-Fi Aware cluster may be configured to follow the same time schedule, e.g., a discovery window (DW), for example, to facilitate cluster formation and/or to achieve low power operation.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a paging message, in accordance with some demonstrative embodiments.

FIG. 3 is a schematic illustration of communications between NAN devices according to a contention mechanism, in accordance with some demonstrative embodiments.

FIG. 4 is a schematic illustration of communications between NAN devices according to a contention mechanism, in accordance with some demonstrative embodiments.

FIG. 5 is a schematic illustration of communications between NAN devices according to a trigger frame transmission mechanism, in accordance with some demonstrative embodiments.

FIG. 6 is a schematic illustration of communications between NAN devices according to a trigger frame transmission mechanism, in accordance with some demonstrative embodiments.

FIG. 7 is a schematic flow-chart illustration of a method of communicating during a timeblock, in accordance with some demonstrative embodiments.

FIG. 8 is a schematic flow-chart illustration of a method of communicating in a data group, in accordance with some demonstrative embodiments.

FIG. 9 is a schematic flow-chart illustration of a method of communicating in a data group, in accordance with some demonstrative embodiments.

FIG. 10 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc, indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc, to describe a common object, merely indicate that different instances of like objects are being referred to, and are not intended to imply that the objects so described must be in a given sequence, either temporally, spatially, in ranking, or in any other manner.

Some embodiments may be used in conjunction with devices and/or networks operating in accordance with existing WiFi Alliance (WFA) Specifications (including Wi-Fi Neighbor Awareness Networking (NAN) Technical Specification, Version 1.0, May 1, 2015) and/or future versions and/or derivatives thereof, devices and/or networks operating in accordance with existing WFA Peer-to-Peer (P2P) specifications (including WiFi P2P technical specification, version 1.5, Aug. 4, 2014) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (including IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); and/or IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE 802.11ax (IEEE 802.11ax, High Efficiency WLAN (HEW)); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments are described herein with respect to WiFi communication. However, other embodiments may be implemented with respect to any other communication scheme, network, standard and/or protocol.

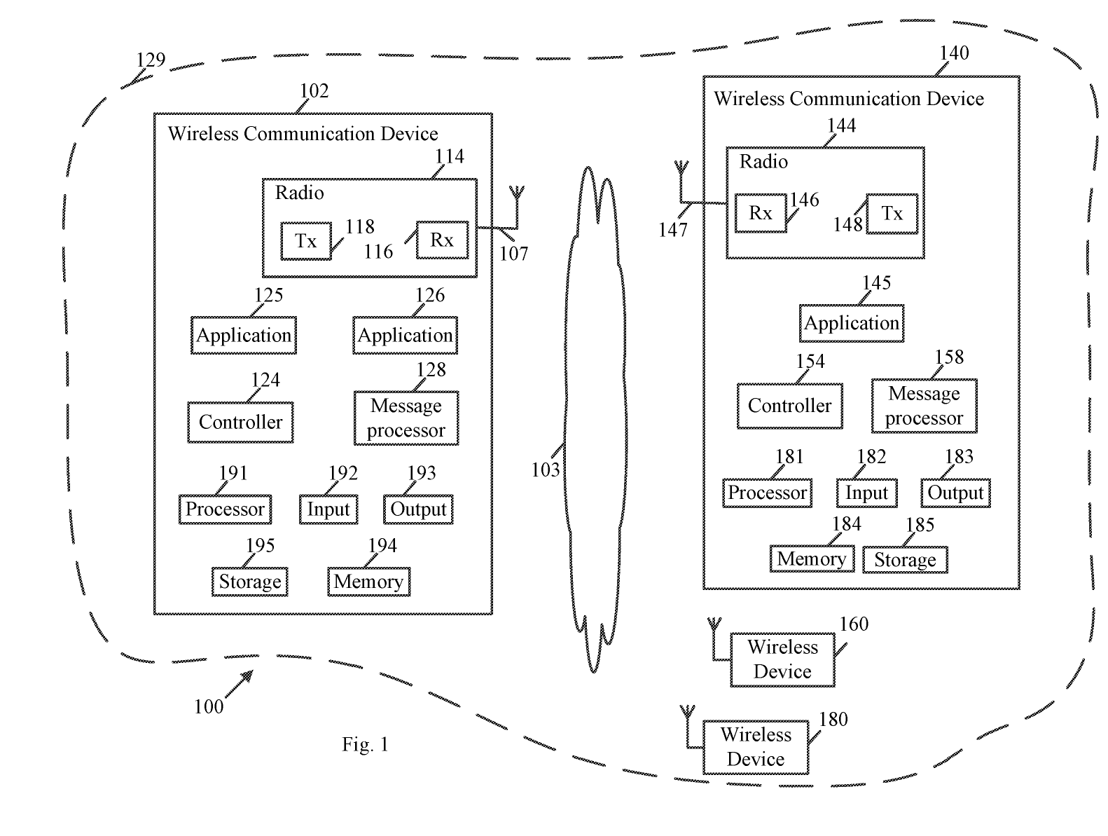

Reference is now made to FIG. 1, which schematically illustrates a block diagram of a system 100, in accordance with some demonstrative embodiments.

As shown in FIG. 1, in some demonstrative embodiments system 100 may include a wireless communication network including one or more wireless communication devices, e.g., wireless communication devices 102, 140, 160 and/or 180.

In some demonstrative embodiments, wireless communication devices 102, 140, 160 and/or 180 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, devices 102, 140, 160 and/or 180 may include, operate as, and/or perform the functionality of one or more STAs. For example, device 102 may include at least one STA, and/or device 140 may include at least one STA.

In some demonstrative embodiments, devices 102, 140, 160 and/or 180 may include, operate as, and/or perform the functionality of one or more WLAN STAs.

In some demonstrative embodiments, devices 102, 140, 160 and/or 180 may include, operate as, and/or perform the functionality of one or more Wi-Fi STAs.

In some demonstrative embodiments, devices 102, 140, 160 and/or 180 may include, operate as, and/or perform the functionality of one or more Bluetooth (BT) devices.

In some demonstrative embodiments, devices 102, 140, 160 and/or 180 may include, operate as, and/or perform the functionality of one or more Neighbor Awareness Networking (NAN) STAs.

In some demonstrative embodiments, devices 102, 140, 160 and/or 180 may include, operate as, and/or perform the functionality of one or more location measurement STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative embodiments, devices 102, 140, 160 and/or 180 may include, operate as, and/or perform the functionality of any other devices and/or STAs.

In some demonstrative embodiments, devices 102, 140, 160 and/or 180 may be configured to operate as, and/or to perform the functionality of, an access point (AP) STA.

In some demonstrative embodiments, devices 102, 140, 160 and/or 180 may be configured to operate as, and/or to perform the functionality of, a non-AP STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In one example, device 102 may be configured to operate as, and/or to perform the functionality of an AP STA, and/or device 140 may be configured to operate as, and/or to perform the functionality of a non-AP STA.

In some demonstrative embodiments, device 102 may include, for example, one or more of a processor 191, an input unit 192, an output unit 193, a memory unit 194, and/or a storage unit 195; and/or devices 140, 160 and/or 180 may include, for example, one or more of a processor 181, an input unit 182, an output unit 183, a memory unit 184, and/or a storage unit 185. Devices 102, 140, 160 and/or 180 may optionally include other suitable hardware components and/or software components. In some demonstrative embodiments, some or all of the components of one or more of devices 102, 140, 160 and/or 180 may be enclosed in a common housing or packaging, and may be interconnected or operably associated using one or more wired or wireless links. In other embodiments, components of one or more of devices 102, 140, 160 and/or 180 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102, 140, 160 and/or 180 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a Wireless Fidelity (WiFi) channel, an IR channel, a Bluetooth (BT) channel, and the like.

In some demonstrative embodiments, wireless communication medium 103 may include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band.

In some demonstrative embodiments, devices 102, 140, 160 and/or 180 may include one or more radios including circuitry and/or logic to perform wireless communication between devices 102, 140, 160, 180 and/or one or more other wireless communication devices. For example, device 102 may include at least one radio 114, and/or device 140 may include at least one radio 144.

In some demonstrative embodiments, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at lest one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radios 114 and/or 144 may be configured to communicate over a 2.4 GHz band, a 5 GHz band, an mmWave band, a S1G band, and/or any other band.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, wireless communication devices 102, 140, 160 and/or 180 may form, and/or may communicate as part of, a wireless local area network (WLAN).

In some demonstrative embodiments, wireless communication devices 102, 140, 160 and/or 180 may form, and/or may communicate as part of, a WiFi network.

In some demonstrative embodiments, wireless communication devices 102, 140, 160 and/or 180 may form, and/or may communicate as part of, a WiFi Direct (WFD) network, e.g., a WiFi direct services (WFDS) network, and/or may perform the functionality of one or more WFD devices.

In one example, wireless communication devices 102, 140, 160 and/or 180 may include, may operate as, and/or may perform the functionality of a WiFi Direct device.

In some demonstrative embodiments, wireless communication devices 102, 140, 160 and/or 180 may be capable of performing awareness networking communications, for example, according to an awareness protocol, e.g., a WiFi aware protocol, and/or any other protocol, e.g., as described below.

In some demonstrative embodiments, wireless communication devices 102, 140, 160 and/or 180 may be capable of forming, and/or communicating as part of, a Neighbor Awareness Networking (NAN) network, e.g., a WiFi NAN or WiFi Aware network, and/or may perform the functionality of one or more NAN devices (“WiFi aware devices”).

In some demonstrative embodiments, wireless communication devices 102, 140, 160 and/or 180 may include, operate as, and/or perform the functionality of one or more High Efficiency WLAN (HEW) STAs.

In some demonstrative embodiments, wireless communication devices 102, 140, 160 and/or 180 may include, operate as, and/or perform the functionality of one or more Low Power Long Range (LPLR) STAs.

Some demonstrative embodiments are described herein with respect to one or more NAN devices communicating as part of a NAN network, e.g., a NAN cluster. However, embodiments are not limited to these demonstrative embodiments, and other embodiments may be implemented with respect to any other type of devices and/or STAs communicating as part of any other group, service set, and/or network.

In some demonstrative embodiments, wireless communication medium 103 may include a direct link, for example, a PTP link, e.g., a WiFi direct P2P link or any other PTP link, for example, to enable direct communication between wireless communication devices 102, 140, 160 and/or 180.

In some demonstrative embodiments, wireless communication devices 102, 140, 160 and/or 180 may perform the functionality of WFD P2P devices. For example, devices 102, 140, 160 and/or 180 may be able to perform the functionality of a P2P client device, and/or P2P group Owner (GO) device.

In other embodiments, wireless communication devices 102, 140, 160 and/or 180 may form, and/or communicate as part of, any other network, and/or may perform the functionality of any other wireless devices or stations.

In some demonstrative embodiments, devices 102, 140, 160 and/or 180 may include one or more applications configured to provide, to share, and/or to use one or more services, e.g., a social application, a file sharing application, a media application and/or the like, for example, using an awareness network, NAN network (“WiFi Aware network”), a PTP network, a P2P network, WFD network, or any other network.

In some demonstrative embodiments, device 102 may execute an application 125 and/or an application 126. In some demonstrative embodiments, device 140 may execute an application 145.

In some demonstrative embodiments, devices 102, 140, 160 and/or 180 may be capable of sharing, showing, sending, transferring, printing, outputting, providing, synchronizing, and/or exchanging content, data, and/or information, e.g., between applications and/or services of devices 102, 140, 160 and/or 180 and/or one or more other devices.

In some demonstrative embodiments, devices 102, 140, 160 and/or 180 may include a controller configured to control one or more operations and/or functionalities of devices 102, 140, 160 and/or 180, for example, one or more operations and/or functionalities of communication, e.g., awareness networking communications, WiFi Aware (NAN) communication and/or any other communication, between devices 102, 140, 160 and/or 180 and/or other devices, and/or any other functionality, e.g., as described below. For example, device 102 may include a controller 124, and/or device 140 may include a controller 154.

In some demonstrative embodiments, controllers 124 and/or 154 may be configured to perform one or more functionalities, communications, operations and/or procedures between wireless communication devices 102, 140, 160 and/or 180, and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In one example, controllers 124 and/or 154 may perform one or more functionalities of a NAN engine, e.g., a NAN discovery engine (DE), for example to process one or more service queries and/or responses, e.g., from applications and/or services on devices 102, 140, 160 and/or 180, and/or one or more other devices.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below. In one example, message processor 128 may be configured to process transmission of one or more messages from a wireless station, e.g., a wireless STA implemented by device 102; and/or message processor 128 may be configured to process reception of one or more messages by a wireless station, e.g., a wireless STA implemented by device 102.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below. In one example, message processor 158 may be configured to process transmission of one or more messages from a wireless station, e.g., a wireless STA implemented by device 140; and/or message processor 158 may be configured to process reception of one or more messages by a wireless station, e.g., a wireless STA implemented by device 140.

In some demonstrative embodiments, message processors 128 and/or 158 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158. Additionally or alternatively, one or more functionalities of message processors 128 and/or 158 may be implemented by logic, which may be executed by a machine and/or one or more processors, e.g., as described below.

In one example, message processors 128 and/or 158 may perform one or more functionalities of a NAN MAC configured to generate, process and/or handle one or more NAN messages, e.g., NAN Beacon frames and/or NAN Service Discovery frames.

In some demonstrative embodiments, at least part of the functionality of message processor 128 may be implemented as part of radio 114.

In some demonstrative embodiments, at least part of the functionality of message processor 128 may be implemented as part of controller 124.

In other embodiments, the functionality of message processor 128 may be implemented as part of any other element of device 102.

In some demonstrative embodiments, at least part of the functionality of controller 124, radio 114, and/or message processor 128 may be implemented by an integrated circuit, for example, a chip, e.g., a System in Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In some demonstrative embodiments, at least part of the functionality of message processor 158 may be implemented as part of radio 144.

In some demonstrative embodiments, at least part of the functionality of message processor 158 may be implemented as part of controller 154.

In other embodiments, the functionality of message processor 158 may be implemented as part of any other element of device 140.

In some demonstrative embodiments, at least part of the functionality of controller 154, radio 144, and/or message processor 158 may be implemented by an integrated circuit, for example, a chip, e.g., a System in Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In some demonstrative embodiments, devices 102, 140, 160 and/or 180 may perform the functionality of a device or station, for example, an awareness networking device, a NAN device, a WiFi device, a WiFi Aware device, a WFD device, a WLAN device, a LPLR device, and/or any other device, capable of discovering other devices according to a discovery protocol and/or scheme.

In some demonstrative embodiments, radios 114 and/or 144 may communicate over wireless communication medium 103 according to an awareness networking scheme, for example, a discovery scheme, for example, a WiFi Aware discovery scheme (“NAN discovery scheme”), and/or any other awareness networking and/or discovery scheme, e.g., as described below.

In some demonstrative embodiments, the awareness networking scheme, e.g., NAN, may enable applications to discover services in their close proximity. For example, the NAN technology may be a low power service discovery, which may, for example, scale efficiently, e.g., in dense Wi-Fi environments.

In some demonstrative embodiments, a device, e.g., wireless communication devices 102, 140, 160 and/or 180, may include one or more blocks and/or entities to perform network awareness functionality. For example, a device, e.g., devices 102, 140, 160 and/or 180, may be capable of performing the functionality of a NAN device, may include a NAN MAC and/or a Discovery Engine (DE). In one example, controllers 124 and/or 154 may be configured to perform the functionality of the discovery engine, and/or message processors 128 and/or 158 may be configured to perform the functionality of the NAN MAC, e.g., as described above. In another example, the functionality of the NAN MAC and/or the Discovery engine may be performed by any other element and/or entity of devices 102, 140, 160 and/or 180.

In some demonstrative embodiments, the awareness networking scheme may include a discovery scheme or protocol, e.g., as described below.

In some demonstrative embodiments, devices 102, 140, 160 and/or 180 may perform a discovery process according to the awareness networking scheme, for example, to discover each other and/or to establish a wireless communication link, e.g., a directional and/or high throughput wireless communication link and/or any other link.

In some demonstrative embodiments, devices 102, 140, 160 and/or 180 may be configured to enable time synchronization between devices 102, 140, 160, 180 and/or one or more other devices, e.g., performing the functionality of Wi-Fi stations (STAs), for example, such that STAs can discover each other more efficiently and/or quickly.

Some demonstrative embodiments are described below with respect to a NAN discovery scheme, and to NAN discovery frames of the NAN discovery scheme. However, in other embodiments, any other discovery scheme and/or discovery frames may be used.

In some demonstrative embodiments, the discovery scheme may include a plurality of contention-based discovery windows (DWs).

In some demonstrative embodiments, communication during the DWs may be configured to enable time synchronization between Wi-Fi stations (STAs), e.g., devices 102, 140, 160 and/or 180, so that STAs can find each other more efficiently during a DW.

In some demonstrative embodiments, devices of an awareness network, e.g., a NAN network, may form one or more clusters, e.g., in order to publish and/or subscribe for services. A NAN cluster may be defined by an Anchor Master (AM) (also referred to as a “NAN master device” or “anchor device”). In one example, the AM may include a NAN device, which has the highest rank in the NAN cluster.

In some demonstrative embodiments, NAN data exchange may be reflected by discovery frames, e.g., Publish, Subscribe and/or Follow-Up Service discovery frames (SDF). These frames may include action frames, which may be sent by a device that wishes to publish a service/application, and/or to subscribe to a published service/application at another end.

In one example, one of devices 102, 140, 160 and/or 180, e.g., device 102, may perform the functionality of an AM. The AM may be configured to transmit one or more beacons. Another one of devices 102, 140, 160 and/or 180, e.g., device 140, may be configured to receive and process the beacons.

In one example, devices 102, 140, 160 and/or 180 may perform the functionality of NAN devices, e.g., belonging to a NAN cluster, which may share a common set of NAN parameters, for example, including a common NAN timestamp, and/or a common time period between consecutive discovery windows (DWs). The NAN timestamp may be communicated, for example, as part of a NAN beacon frame, which may be communicated in the NAN cluster. In one example, the NAN timestamp may include a Time Synchronization Function (TSF) value, for example, a cluster TSF value, or any other value.

In some demonstrative embodiments, devices 102, 140, 160 and/or 180 may be configured to discover one another over a predefined communication channel (“the social channel”). In one example, the Channel 6 in the 2.4 GHz band may be defined as the NAN social channel Any other channel may be used as the social channel.

In some demonstrative embodiments, devices 102, 140, 160 and/or 180 may transmit discovery frames, e.g., SDFs, during the plurality of DWs, e.g., over the social channel. For example the NAN AM may advertize the time of the DW, during which NAN devices may exchange SDFs.

In one example, devices 102, 140, 160 and/or 180 may transmit the discovery frames to discover each other, for example, to enable using the one or more services provided by applications 125 and/or 126.

In some demonstrative embodiments, devices 102, 140, 160 and/or 180 may communicate during a DW according to a contention mechanism. For example, devices 102, 140, 160 and/or 180 may check whether or not a channel is unoccupied prior to an attempt to transmit a discovery frame during the discovery window.

In some demonstrative embodiments, a device of devices 102, 140, 160 and/or 180, e.g., device 102, may not transmit the discovery frame during the DW, e.g., if the channel is occupied. In some demonstrative embodiments, device 102 may transmit the discovery frame during the DW, e.g., if the channel is unoccupied.

In some embodiments, the discovery frame may be transmitted as a group addressed, e.g., broadcast or multicast, discovery frame. In other embodiments, the discovery frame may be transmitted as any other type of frame.

In some demonstrative embodiments, the discovery frame may not require an acknowledgement frame. According to these embodiments, a transmitter of the discovery frame may not backoff a transmission of the discovery frame.

In some demonstrative embodiments, the discovery frame transmitted by device 102 during the DW may be configured to enable other devices or services that are running on other devices to discover the services on device 102.

In some demonstrative embodiments, devices of system 100 may utilize availability information, e.g., in the form of an Availability Interval Bitmap and/or Further Availability Map, for example, to allow a device of devices 102, 140, 160 and/or 180, to advertise its availability, for example, in terms of at least one channel and one or more timeslots, during which the device may be available, e.g., active (“awake”), for example, to perform post NAN activities.

In one example, the availability information may be communicated as part of an Availability Attribute, e.g., including a 32-bit bitmap for 32 timeslots, for example, wherein each timeslot is 16 milliseconds (ms) long. For example, each bit that is not zero may represent a timeslot, during which a device sending the Availability Attribute is to be awake and available to send and/or receive data in a specified method.

In some demonstrative embodiments, devices 102, 140, 160 and/or 180 may be part of an awareness cluster, e.g., a NAN cluster.

In some demonstrative embodiments, devices 102, 140, 160 and/or 180 may form the NAN cluster.

In some demonstrative embodiments, devices 102, 140, 160 and/or 180 may be configured to communicate according to a Wi-Fi Aware specification and/or any other awareness networking specification, which may be configured to allow a group of devices to discover other devices/services nearby and/or in close proximity, e.g., with low power.

In some demonstrative embodiments, devices 102, 140, 160 and/or 180 may form the NAN cluster and may synchronize to the same clock, e.g., as described above.

In one example, all devices of the NAN cluster, may converge on a time period and channel, e.g., a DW, to facilitate the discovery of services of devices 102, 140, 160 and/or 180, and/or to achieve low power consumption, e.g., as described above.

In some demonstrative embodiments, devices 102, 140, 160 and/or 180 may be configured to enable data transmission for a specific service among multiple devices, post service discovery.

In some demonstrative embodiments, to enable data transmission post service discovery between two devices, the two devices may be required to use a common schedule, e.g., to be available at a same channel at a same time.

In some demonstrative embodiments, device 102 may be configured to determine the schedule for data transmission post service discovery with devices 140, 160 and/or 180, for example, based on a base schedule, e.g., as described below.

In some demonstrative embodiments, devices 102, 140, 160 and/or 180 may be configured to utilize schemes, which may enable devices 102, 140, 160 and/or 180 to transmit data to each other, e.g., without any infrastructure, e.g., directly and/or without using an AP or any other infrastructure device.

In some demonstrative embodiments, after the discovery process, a set of devices of a cluster, e.g., devices 102, 140, 160 and/or 180, may form a group, e.g., a data link group (“data group”).

In some demonstrative embodiments, devices 102, 140, 160 and/or 180 may form data group 129.

In some demonstrative embodiments, devices 102, 140, 160 and/or 180 of the data link group 129 may be configured to meet on fixed time periods and channels, which may be referred to as “timeblocks”, to communicate with each other.

In some demonstrative embodiments, an announcement of the timeblocks may be made by a device in the group, e.g., during the discovery window.

In some demonstrative embodiments, a timeblock, e.g., each timeblock, may include, or may be divided into, at least a Negotiation Time (NT), and/or a Data Transmission Time (DTxT), e.g., as described below.

In some demonstrative embodiments, during the NT (also refereed to as a “Paging Time” or “Traffic Indication Time”), devices of data group 129 may negotiate with each other to find out whether they have traffic for each other, for example, by transmitting paging messages and/or any other messages.

In some demonstrative embodiments, the size of an NT may be small, for example, to enable power conservation. For example, a reduced NT may reduce the time for which devices that do not have packets to transmit or receive, remain awake.

In some demonstrative embodiments, during the DTxT, data exchange may take place, for example, between two or more devices of data group 129.

In some demonstrative embodiments, a device of data group 129, e.g., device 102, may determine whether or not the device may transmit and/or receive data during a DTxT, for example, based on the paging messages, e.g., during the NT.

In some demonstrative embodiments, devices of data group 129 without data to transmit and/or receive during the DTxT may remain a sleep, e.g., during the DTxT.

In some demonstrative embodiments, a first device of data group 129 (“a paging device”) may transmit a paging message to a second device of data group 129 (“a paged device”) during the NT, for example, to indicate to the paged device that the paging device is to transmit data to the paged device during the DTxT.

In some demonstrative embodiments, data exchange, e.g., during the DTxT, may begin, for example, when the paged device transmits an indication frame (“trigger frame”), for example, a Quality of Service (QoS) Null (QoS-NULL) frame, to the paging device, for example, to inform the paging device that the paged device is ready to receive data.

In some demonstrative embodiments, the paging device may send one or more data packets, for example, in response to the indication frame.

In some demonstrative embodiments, high priority packets, e.g., packets with stringent deadline requirements, e.g., video, voice, and the like, may be transmitted with high priority, for example, ahead of other packets, for example, low priority packets, e.g., best-effort, background, and/or the like, for example, in order to ensure quality of service (QoS) of the high priority packets.

In some demonstrative embodiments, in some situations, several devices of data group 129 may try to transmit data, e.g., high priority packets and/or low priority packets, within the same timeblock. Such situations may lead to congestion during the timeblock.

Some demonstrative embodiments may be configured to provide a mechanism to provide QoS for data transmissions in data group 129, e.g., as described below.

Some demonstrative embodiments may include a paging mechanism configured to determine how devices of data group 129 exchange data during a DTxT, for example, while ensuring QoS and/or mitigating congestion during the DTxT, e.g., as described below.

In some demonstrative embodiments, the paging mechanism may be configured to specify how a paged device transmits QoS-NULL frames to the paging devices during the DTxT, for example, while simultaneously mitigating congestion and/or providing QoS, e.g., as described below.

In some demonstrative embodiments, the paging mechanism may be, for example, different from mechanisms that provide QoS in other networks, e.g., an Enhanced Distributed Channel Access (EDCA) mechanism in a network, for example, in accordance with an IEEE 802.11e Specification.

In some demonstrative embodiments, the paging mechanism may be configured to use one or more unique features of Wi-Fi Aware and/or any other protocol, for example, information about future transmissions gathered by overhearing in NT.

Some demonstrative embodiments may provide a distributed scheme, for example, in which transmission of trigger frames, e.g., QoS-NULL frames, from a paged device, e.g., any paged device, may be adaptive to the traffic load as well as the type of data, e.g., whether the traffic is video, best-effort, or any other type of traffic, which may be buffered at the paging device for the paged device.

In some demonstrative embodiments, a paging device of data group 129, e.g., device 102, may be configured to process and/or communicate a paging message, e.g., a new paging message, which may be configured to inform a paged device of data group 129, e.g., device 140, about the type of data buffered for the paged device at the paging device, e.g., as described below.

In some demonstrative embodiments, the paging message may have a structure, which may be configured to contain a list of paged devices of data group 129, for one or more data types, for example, for every buffered data type, e.g., as described below.

Some demonstrative embodiments may include a new paging message structure, which may be configured, for example, to transmit QoS information during an NT, e.g., as described below.

In some demonstrative embodiments, devices of data group 129, e.g., devices 102, 140, 160 and/or 180, may be configured to use the QoS information, for example, to exchange data, for example, while also mitigating congestion during the DTxT, e.g., as described below.

In some demonstrative embodiments, devices of data group 129, e.g., devices 102, 140, 160 and/or 180, may be configured to utilize one or more mechanisms to exchange data during the DTxT, e.g., as described below.

In some demonstrative embodiments, the mechanisms may determine, for example, how paged devices begin data exchange, e.g., as described below.

In some demonstrative embodiments, device 102 may be configured to generate and transmit a paging message including the QoS information, e.g., as described below.

In some demonstrative embodiments, controller 124 may be configured to control, cause and/or trigger device 102 and/or message processor 128 to generate a paging message including one or more list elements corresponding to one or more class types.

In some demonstrative embodiments, the one or more list elements may correspond to one or more respective class types. For example, each list element may correspond to a respective different class type.

In some demonstrative embodiments, a list element may correspond to two or more class types. In one example, a list element may correspond to a traffic type having one or more predefined attributes. The traffic type may include traffic sharing one or more common traffic type attributes.

In one example, the one or more list elements may include a multicast list element corresponding to multicast traffic, e.g., as described below.

In another example, the one or more list elements may include a unicast list element corresponding to unicast traffic, e.g., as described below.

In other embodiments, the one or more list elements may include any other list element corresponding to any additional or alternative type of traffic.

In some demonstrative embodiments, a list element of the one or more list elements corresponding to a class type may be configured to indicate one or more devices of data group 129 for which data of the class type is pending for transmission at device 102.

In some demonstrative embodiments, controller 124 may be configured to control, cause and/or trigger device 102 to include an indication of a device of the data group 129, for example, only in a list element corresponding to a class type of a highest priority, for which data is pending transmission at device 102 for the device of the data group 129.

In some demonstrative embodiments, the list element corresponding to the class type may include one or more identifiers of the one or more devices of the data group 129 for which data of the class type is pending transmission at device 102.

In some demonstrative embodiments, the one or more list elements may include at least four list elements corresponding to at least four respective class types.

In some demonstrative embodiments, the at least four list elements may include at least a Video (VI) list element, a Voice (VO) list element, a best Effort (BE) list element, and a Background (BK) list element, and/or any other additional or alternative types of list elements corresponding to tone or more additional or alternative class types.

In some demonstrative embodiments, the one or more list elements may include at least a multicast list element, for example, to indicate one or more devices of data group 129, for which multicast data is pending.

In some demonstrative embodiments, the one or more list elements may include at least a unicast list element, for example, to indicate one or more devices of data group 129, for which unicast data is pending. In one example, the unicast list element may indicate one or more devices of data group 129, for which unicast data of any class type is pending, e.g., VI, VO, BE and/or BK.

In some demonstrative embodiments, the paging message may include the multicast link element to indicate one or more devices of data group 129, for which multicast data is pending, e.g., VI multicast data, VO multicast data, BE multicast data and/or BK unicast data; and the unicast link element to indicate one or more devices of data group 129, for which unicast data is pending, e.g., VI unicast data, VO unicast data, BE unicast data and/or BK unicast data.

In some demonstrative embodiments, controller 124 may be configured to control, cause and/or trigger device 102 and/or transmitter 128 to transmit the paging message during a Negotiation time (NT) in a timeblock of the data group 129.

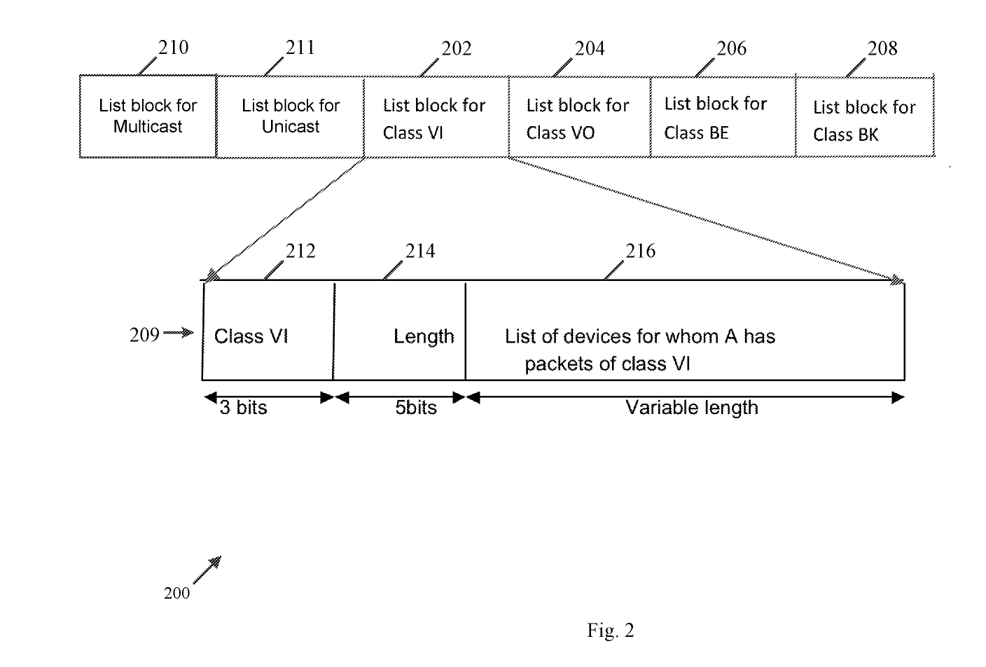

Reference is made to FIG. 2, which schematically illustrates a paging message 200, in accordance with some demonstrative embodiments.

In some demonstrative embodiments, device 102 (FIG. 1) may be configured to generate and transmit the paging message 200, and/or devices 140, 160 and/or 180 (FIG. 1) may be configured to process paging message 200 from device 102 (FIG. 1).

In some demonstrative embodiments, paging message 200 may have a structure configured to carry QoS Information, e.g., as described below.

In some demonstrative embodiments, data traffic may be classified into a plurality of classes.

In some demonstrative embodiments, the data traffic may be classified into 4 classes, e.g., as described below. In other embodiments, the data traffic may be classified into any other number and/or type of classes.

In some demonstrative embodiments, the data traffic may be classified into 4 classes, for example, including one or more of the classes of an Enhanced Distributed Channel Access (EDCA) scheme, e.g., according to an IEEE 802.11 Specification, and/or any other specification.

In some demonstrative embodiments, the data traffic may be classified into at least four classes, for example, including Video (VI), Voice (VO), Best-effort (BE), and/or Background (BK). For example, packets of class VI, e.g., video packets, may have a highest priority of transmission while packets of class BK, e.g., background packets, may have a lowest priority.

In some demonstrative embodiments, as shown in FIG. 2, paging message 200 may include a list element 202 for class VI, a list element 204 for class VO, a list element 206 for class BE, and/or a list element 208 for class BK.

In other embodiments, paging message 200 may include one or more alternative list elements corresponding to one or more additional or alternative class types.

In other embodiments, paging message 200 may include any other number of list elements, e.g., less than four or more than four list elements.

In some demonstrative embodiments, one or more additional classes may be defined, for example, multicast or broadcast traffic may be indicated by a Multicast (MC) class.

In some demonstrative embodiments, as shown in FIG. 2, paging message 200 may include a multicast list element 210 to list devices for which multicast data is pending.

In some demonstrative embodiments, as shown in FIG. 2, paging message 200 may include a unicast list element 211 to list devices for which unicast data is pending.

In some demonstrative embodiments, paging message 200 may include multicast list element 210 to indicate devices for which multicast data of any type, e.g., VI, VO, BE and/or BK, is pending; and unicast list element 211 to indicate devices for which unicast data of any type, e.g., VI, VO, BE and/or BK, is pending. According to these embodiments, a paging device may select to generate paging message including list elements 210 and/or 211, e.g., while selecting not to include in paging message 200 one or more of, e.g., or even any of, list elements 202, 204, 206, and/or 208.

In some demonstrative embodiments, as shown in FIG. 2, list element 202 for class VI may have a structure 209.

In some demonstrative embodiments, a structure for other classes, e.g., the classes VO, BE, BK and/or multicast, may have a structure similar to the structure 209 of class VI, or a different structure.

In some demonstrative embodiments, as shown in FIG. 2, structure 209 may include a class identifier 212 including an identifier of the class, e.g., a value to indicate the class VI.

In some demonstrative embodiments, as shown in FIG. 2, structure 209 may include a list of devices 216 for which data of the class VI is pending transmission. For example, packet 200 may include a list for every packet class, e.g., of the four packet classes.

In some demonstrative embodiments, the list of devices 216 may represent a group of devices for which the paging device has buffered packets of the same class indicated by the class identifier 212.

In some demonstrative embodiments, paging message 200 may be implemented for unicast transmissions and/or multicast transmissions.

In some demonstrative embodiments, as shown in FIG. 2, structure 209 may include a length field 214 configured to indicate, e.g., for every class, the length of list of devices 216, which may be a variable.

In some demonstrative embodiments, the list of devices 216 may be created and/or defined according to one or more rules, e.g., one or more of the rules described below.

In some demonstrative embodiments, in order, for example, to maintain a reduced paging message size, if a paging device, e.g., device 102 (FIG. 1), has multiple classes of packets to transmit to a paged device, e.g., device 140 (FIG. 1), then the indication for the paged device may be included, for example, in only some of the lists corresponding to the classes. For example, the indication for the paged device may be included in one or more lists corresponding to one or more highest priorities of the classes.

In one example, the indication for the paged device may be included, for example, only in the list corresponding to the highest priority class of packets pending for the paged device. For example, if the paging device has buffered packets of both class VI and BE for the paged device, then in the paging message 200, the paged device may only be included in the list of device 216 corresponding to the class VI, e.g., while not including the paged device in the list of devices 216 corresponding to the class BE.

In some demonstrative embodiments, the list of devices 216 may include one or more of the following device identifiers:

NAN Data Link Identifier of the devices belonging to the list;

MAC address of the devices belonging to the list;

Hashed MAC address of the devices belonging to the list;

A bloom filter of the devices belonging to the list; and/or

Any other format configured to identify the devices belonging to the list of devices 216.

Referring back to FIG. 1, in some demonstrative embodiments, a paging device, e.g., device 102, may be configured to transmit a paging message, e.g., paging message 200 (FIG. 2) to a paged device, e.g., device 140, for example, during the NT in the timeblock of the data group 129.

For example, device 102 may transmit the paging message to device 140, for example, if data for device 140 is pending at device 102.

In some demonstrative embodiments, the paged device, e.g., device 140, may be configured to receive the paging message, e.g., paging message 200 (FIG. 2), from the paging device.

In some demonstrative embodiments, the paged device, e.g., device 140, may decode the message to determine, for example, which, classes of data, if any, are pending to be transmitted to the paged device, e.g., from the paging device, e.g., as described below.

In some demonstrative embodiments, if the paged device, e.g., device 140, is listed in multiple list blocks, the paged device may assume, for example, that it is listed at least, or only, in the list block corresponding to the highest priority class, which lists the paged device.

In some demonstrative embodiments, controller 154 may be configured to control, cause and/or trigger device 140 and/or receiver 146 to process one or more paging messages, e.g., paging messages 200 (FIG. 2), from one or more paging devices during the NT in the timeblock of data group 129.

In some demonstrative embodiments, a paging message of the one or more paging messages 200 (FIG. 2) may include an indication of at least one class type of data pending for device 140.

For example, device 140 may receive the paging message 200 (FIG. 2) from device 102, e.g., if data for device 140 is pending at device 102.

In some demonstrative embodiments, controller 154 may be configured to control, cause and/or trigger device 140 and/or transmitter 148 to transmit one or more trigger messages (also referred to as “indication messages”) to the one or more paging devices, e.g., device 102, during a DTxT following the NT, for example, based on the one or more paging messages.

In some demonstrative embodiments, a trigger message may be configured to trigger, and/or to indicate a request to the paging device for, transmission of data pending for device 140.

In some demonstrative embodiments, the trigger message may include a unicast trigger message from device 140 to device 102.

In some demonstrative embodiments, the trigger message may include a multicast trigger message from device 140 to a plurality of NAN devices of data group 129, e.g., including device 102 and one or more other devices from which device 140 has received a paging message.

In some demonstrative embodiments, device 140 may be configured to transmit a multicast trigger message to devices of data group 129 from which paging messages indicate data of the same class type is pending for device 140.

In some demonstrative embodiments, device 140 may be configured to transmit a multicast trigger message to devices of data group 129 from which paging messages indicate data of the different class types are pending for device 140.

In some demonstrative embodiments, the trigger message may include a Quality of Service (QoS) Null frame, and/or any other type of frame.

In some demonstrative embodiments, a paged device of data group 129, e.g., device 140, may be configured to contend for channel access, for example, prior to transmitting a trigger message, for example, prior to every QoS-NULL frame transmission, e.g., as described below.

In some demonstrative embodiments, a size of a contention window and/or a contention start time, which may be used for the contention, may vary, for example, with packet priority as well as information overheard during NT, e.g., as described below.

In some demonstrative embodiments, controller 154 may be configured to control, cause and/or trigger device 140 to determine one or more parameters of a contention window corresponding to the class type of the data pending for device 140.

In some demonstrative embodiments, controller 154 may be configured to control, cause and/or trigger device 140 to determine the one or more parameters of the contention window corresponding to the class type, for example, based at least on a class type of the data to be transmitted to paged device 140.

In some demonstrative embodiments, controller 154 may be configured to control, cause and/or trigger device 140 to contend to transmit a trigger message during the contention window.

In some demonstrative embodiments, the trigger message may request transmission of the data of the class type pending for device 140.

For example, device 140 may transmit a trigger message to device 102 to request transmission of the data of the class type pending for device 140, e.g., at device 120.

In some demonstrative embodiments, controller 154 may be configured to control, cause and/or trigger device 140 to determine a duration of the contention window based on a priority of the class type of the data pending for device 140, e.g., as described below.

In some demonstrative embodiments, a paged device e.g., device 140, may be configured to maintain separate access categories for every paging device, from which device 140 expects to receive traffic from.

In some demonstrative embodiments, a paged device e.g., device 140, may be configured to maintain a single access category for every paging device from which device 140 expects to receive traffic of the same class.

In some demonstrative embodiments, multiple paging devices may be indicated in a single trigger message, e.g., a single QoS-NULL frame transmission, for example, if device 140 maintains the single access category for every paging device.

In some demonstrative embodiments, an access category, e.g., each access category, may contend to transmit QoS-NULL frames, for example, by counting down a random backoff timer, e.g., similar to a backoff timer of an EDCA mechanism, or any other backoff timer.

In some demonstrative embodiments, initial values for backoff timers may be selected as a random value uniformly distributed in a contention window, e.g., as described below.

In some demonstrative embodiments, device 140 may utilize one or more algorithms to determine one or more parameters of the contention window.

In some demonstrative embodiments, device 140 may utilize a first algorithm (“ALG1”), a second algorithm (“ALG2”), and/or any other algorithm, to determine the one or more parameters of the contention window, e.g., as described below.

In some demonstrative embodiments, when receiving a trigger message, e.g., a QoS-NULL frame, e.g., during the contention window, the paging devices may begin to transmit data to the paged device, for example, immediately or after backing off for a random duration, e.g., as described below.

In some demonstrative embodiments, device 140 may utilize the first algorithm, e.g., as described below.

In some demonstrative embodiments, in the first algorithm, the backoff timer countdown for an access category may begin, for example, at a backoff start time, which may be proportional to a time offset, e.g., in the NT, when the paged device, e.g., device 140, has received the corresponding paging message, e.g., as described below.

In some demonstrative embodiments, limiting the number of devices that contend simultaneously can reduce collision probability of QoS-NULL frames, for example, especially in presence of a large number of devices, for example, when using a back-off start time, which is proportional to the time offset.

In some demonstrative embodiments, controller 154 may be configured to control, cause and/or trigger device 140 to determine a beginning of the contention window for transmitting a trigger message corresponding to a paging message, for example, based on a timing of the paging message.

In some demonstrative embodiments, controller 154 may be configured to control, cause and/or trigger device 140 to select an interval from a predefined number of intervals in the DTxT, for example, based on the timing of the paging message, and to begin the contention window at a beginning of the interval, e.g., as described below.

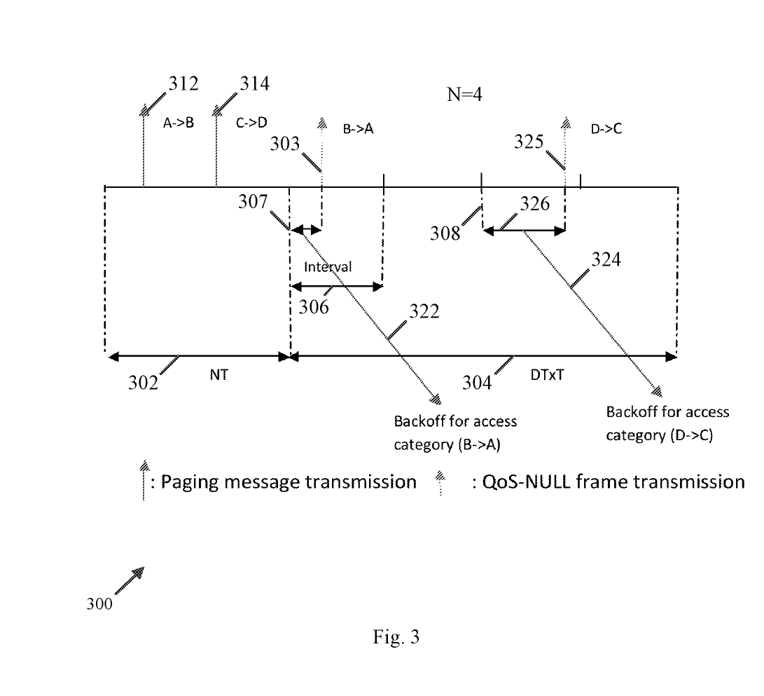

Reference is made to FIG. 3, which schematically illustrates communications between NAN devices according to a contention mechanism 300. For example, one or more of the NAN devices of data group 129 (FIG. 1) may communicate according to contention mechanism 300.

In some demonstrative embodiments, device 140 may be configured to implement contention mechanism 300 according to the first algorithm described above.

In some demonstrative embodiments, as shown in FIG. 3, the communications between the NAN devices may be performed during a negotiation time (NT) 302 followed by a DTxT 304.

In some demonstrative embodiments, as shown in FIG. 3, during the NT 302 the NAN devices may transmit paging messages. For example, a first device, denoted A, may send a paging message 312 to a second device, denoted B, for example, to indicate to device B that device A has pending data to transmit to device B during the DTxT 304; and/or a third device, denoted C, may send a paging message 314 to a fourth device, denoted D, for example, to indicate to device D that device C has pending data to transmit to device D during the DTxT 304. In one example, the symbol “->” denotes the direction of transmission. For example, “A->B” indicates transmission from device A to device B.

In some demonstrative embodiments, as shown in FIG. 3, the DTxT 304 may include, or may be divided into a plurality of intervals 306.

In some demonstrative embodiments, as shown in FIG. 3, the DTxT 304 may include, or may be divided into, for example, N intervals, e.g., N=4.

In some demonstrative embodiments, the plurality intervals may include N intervals denoted (t_{start,1}, t_{end,1}), . . . , (t_{start,N}, t_{end,N}), wherein t_{start,i} denotes the start of an i-th interval and t_{end,1} denotes an end time of the i-th interval, and wherein 1≦i≦N.

In some demonstrative embodiments, the number of intervals N may be, for example, fixed across timeblocks, and may be known, e.g., to all the NAN devices of the data group 129 (FIG. 1).

In some demonstrative embodiments, according to contention mechanism 300, an access category, e.g., each access category, in a device, e.g., device B, may select the interval in which the device may begin contending to transmit a QoS-NULL frame, for example, based on the time instant when the device received a corresponding paging message.

For example, the device may receive m paging messages, denoted p₁, . . . , pₘ, for example, at m respective times, denoted tₚ₁, . . . , tₚₘ, e.g., in microseconds (us). According to this example, the access category corresponding to the paging message pᵢ may begin contending in the Nᵢ-th interval. The value of Nᵢ may be determine, for example, to be high, for example, if the time tₚᵢ is close to the end of NT 302, and vice versa.

In one example, a paged device, e.g., device 140 (FIG. 1), may be configured to determine the interval Nᵢ, e.g., as follows:

$${N}_{i} = [ ( {t}_{pi} - {t}_{start , NT} ) \frac{N}{length ( NT )} ] + 1 \qquad ( 1 )$$

wherein t_{start,NT} denotes a start time of the NT, e.g., in us, and length(NT) denotes the length of the NT, e.g., in us. The notation [x] denotes the largest integer not greater than x.

In some demonstrative embodiments, according to contention mechanism 300, a paged device, for example, device 140 (FIG. 1), e.g., device B, may select one or more contention window parameters based on the packet class pending for the page device, e.g., as indicated by the paging message 200 (FIG. 2). For example, the paged device may select long contention windows for buffered packets of a low priority, e.g., the class BK, and/or short contention windows for buffered packets of a high priority, e.g., the class VI.

In some demonstrative embodiments, according to contention mechanism 300, a paged device, for example, device 140 (FIG. 1), e.g., device B, may increase and/or decrease a contention window size on unsuccessful and/or successful QoS-NULL frame transmissions, respectively.

In some demonstrative embodiments, device B and device D may determine the contention interval to be used to transmit QoS-NULL messages in the DTxT 304, for example, based on the timing of the paging messages, e.g., during the NT 302.

In some demonstrative embodiments, as shown in FIG. 3, device B may determine a beginning 307 of a first interval 306 to start contend the medium, and may determine a backoff 322, e.g., before transmitting a trigger message, e.g., a QoS-Null frame 323, to device A.

In some demonstrative embodiments, as shown in FIG. 3, device D may determine a beginning 308 of a second interval 326 to start to contend the medium, and may determine a backoff 324, e.g., before transmitting a trigger message, e.g., a QoS-Null frame 325, to device C.

Referring back to FIG. 1, in some demonstrative embodiments, a paged device, e.g., device 140, may utilize the second algorithm, for example, to determine the one or more parameters of the contention window, e.g., as described below.

In some demonstrative embodiments, a time at which a paging message is transmitted may be a measure of channel congestion.

In some demonstrative embodiments, according to the second algorithm, an access category, e.g., every access category, may adapt its contention window, for example, based on its knowledge of other devices that are simultaneously contending, e.g., as described below.

In some demonstrative embodiments, varying the contention window length based on the number of devices contending for the medium may enable, for example, to reduce collision probability of QoS-NULL frame transmissions, e.g., especially for short default contention windows.

In some demonstrative embodiments, controller 154 may be configured to control, cause and/or trigger device 140 to determine a beginning of the contention window to contend to transmit a trigger message corresponding to a paging message, for example, based on a number of paging messages, which are received prior to the paging message, and which indicate a same class type as the class type of the data pending for device 140, e.g., as described below.

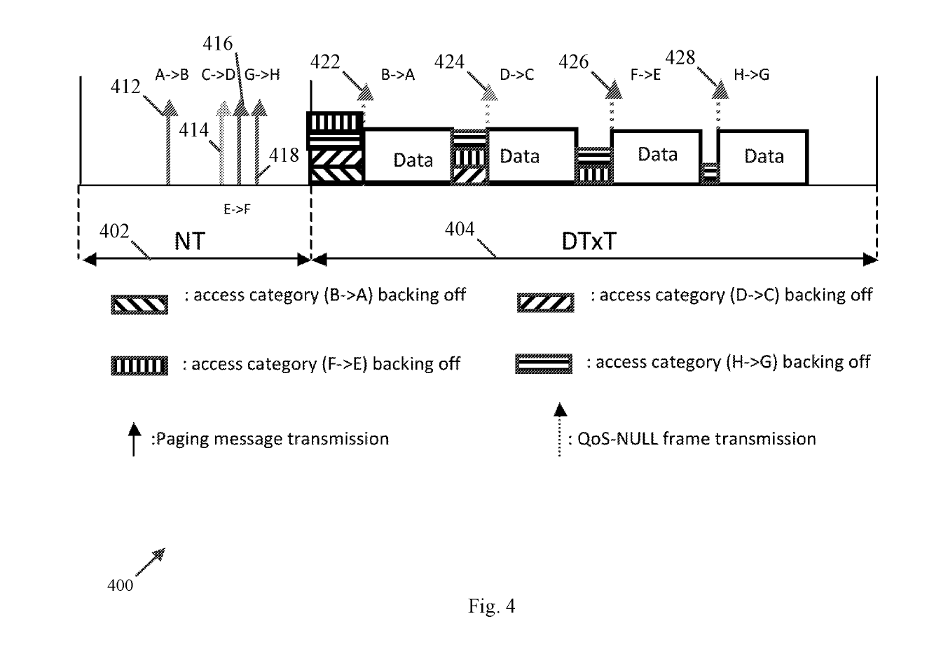

Reference is made to FIG. 4, which schematically illustrates communications between NAN devices according to a contention mechanism 400. For example, one or more of the NAN devices of data group 129 (FIG. 1) may communicate according to contention mechanism 400.

In some demonstrative embodiments, device 140 (FIG. 1) may be configured to implement contention mechanism 400 according to the second algorithm described above.

In some demonstrative embodiments, as shown in FIG. 4, the communications between the NAN devices may be performed during a negotiation time (NT) 402 followed by a DTxT 404.

In some demonstrative embodiments, as shown in FIG. 4, during the NT 402 the NAN devices may transmit paging messages. For example, a first device, denoted A, may send a paging message 412 to a second device, denoted B, for example, to indicate to device B that device A has pending data of a first access category to transmit to device B during the DTxT 404; a third device, denoted C, may send a paging message 414 to a fourth device, denoted D, for example, to indicate to device D that device C has pending data of a second access category to transmit to device D during the DTxT 404; a fifth device, denoted E, may send a paging message 416 to a sixth device, denoted F, for example, to indicate to device F that device E has pending data of a third access category to transmit to device F during the DTxT 404; and/or a seventh device, denoted G, may send a paging message 418 to an eighth device, denoted H, for example, to indicate to device H that device G has pending data of a fourth access category to transmit to device H during the DTxT 404.

In some demonstrative embodiments, as shown in FIG. 4, the paging message 4143 may be sent after the paging message 412, the paging message 416 may be sent after the paging message 414, and the paging message 418 may be sent after the paging message 416.

In one example, the symbol “->” denotes the direction of transmission. For example, “A->B” indicates transmission from device A to device B.

In some demonstrative embodiments, according to contention mechanism 400, a paged device, for example, device 140, e.g., device B, may determine a time to transmit a trigger message, e.g., a QoS-NULL message, for example, based on an estimated number of transmissions corresponding to a class type, e.g., intended for transmission during the DTxT 404.

In some demonstrative embodiments, according to contention mechanism 400, a paged device, e.g., device 140 (FIG. 1), may receive m paging messages, denoted p₁, . . . , pₘ, for example, at m respective times, denoted tₚ₁, . . . tₚₘ (in us).

In some demonstrative embodiments, the paged device, e.g., device 140 (FIG. 1), may be configured to record, e.g., for every i (wherein 1≦i≦m), for example, by overhearing transmissions during the NT 404, the number of other access categories, n, that:
correspond to the same class of packets as the access category in the paged device corresponding to the paging message pᵢ, and whose
corresponding paging messages were not transmitted after the time tₚᵢ.

In some demonstrative embodiments, the paged device may select one or more contention window parameters for the access category corresponding to the paging message pᵢ, for example, based on the packet class and the number n, e.g., as described below.

In some demonstrative embodiments, the class cᵢ, e.g., wherein cᵢ □{VI, VO, BE, BK} and/or any other predefined classes, may denote the class of packets indicated for the device A in the paging message pᵢ.

In some demonstrative embodiments, the contention window length for this access category may be set, for example, as CW_DEF_LEN+ƒ(n), wherein CW_DEF_LEN denotes a default contention window length for the class cᵢ.

For example, according to contention mechanism 400, the paged device may select large values of CW_DEF_LEN for packets of low priority, e.g., of the class BK, and/or small values of CW_DEF_LEN for packets of a high priority, e.g., the class VI. The function ƒ(n) may include, for example, a non-decreasing function of n. For example, ƒ(n)=kn, wherein k is a positive constant, or any other function.

In some demonstrative embodiments, according to contention mechanism 400, the paged device, e.g., device 140 (FIG. 1), may be configured to increase and/or decrease a contention window size on unsuccessful and/or successful QoS-NULL frame transmissions, respectively.

In some demonstrative embodiments, as shown in FIG. 4, device B may transmit a trigger message, e.g., a QoS-Null frame 422, to device A, for example, according to contention mechanism 400.

In some demonstrative embodiments, as shown in FIG. 4, device D may transmit a trigger message, e.g., a QoS-Null frame 424, to device C, for example, according to contention mechanism 400.

In some demonstrative embodiments, as shown in FIG. 4, device F may transmit a trigger message, e.g., a QoS-Null frame 426, to device E, for example, according to contention mechanism 400.

In some demonstrative embodiments, as shown in FIG. 4, device H may transmit a trigger message, e.g., a QoS-Null frame 428, to device G, for example, according to contention mechanism 400.

Referring back to FIG. 1, in some demonstrative embodiments, device 102 may process a trigger message from device 140, e.g., a trigger message sent according to contention mechanism 300 (FIG. 3) or contention mechanism 400 (FIG. 4), or any other contention mechanism.

In some demonstrative embodiments, controller 124 may be configured to control, cause and/or trigger device 102 and/or receiver 116 to process a trigger message from a paged device of the data group 129, e.g., during a DTxT, e.g., DTxT 304 (FIG. 3) or DTxT 404 (FIG. 4), following an NT, e.g., NT 302 (FIG. 3) or NT 402 (FIG. 4), respectively.

In some demonstrative embodiments, controller 124 may be configured to control, cause and/or trigger device 102 and/or transmitter 118, to transmit data to the paged device during the DTxT, for example, based on the trigger message.

In some demonstrative embodiments, upon receiving a trigger frame, a paging device, e.g., device 102, may contend before transmitting the data to the sender of the trigger frame, e.g., device 140, for example, if the received trigger frame is a unicast trigger frame or a multicast trigger frame.

In some demonstrative embodiments, the paging device, e.g., device 102, may be configured to use a contention window to contend for transmission of the data to the paged device from which the trigger message is received.

In some demonstrative embodiments, a length of the contention window may be, for example, a function of highest priority of buffered data for the sender of the trigger frame.

In other embodiments, the length of the contention window may be, for example, based on any other function or method.

In some demonstrative embodiments, devices of data group 129 may utilize one or more other algorithm and/or mechanisms to communicate and/or to exchange data, for example, during the DTxT, e.g., as described above.

In some demonstrative embodiments, devices 102, 140, 160, and/or 180 may be configured to utilize one or more algorithms and/or mechanisms, for example, to communicate and/or to exchange data, for example, during the DTxT, e.g., as described below.

In some demonstrative embodiments, devices 102, 140, 160, and/or 180 may be configured to utilize traffic class information, e.g., the QoS information in the paging message 200 (FIG. 2), for example, to communicate and/or to exchange data during the DTxT.

In some demonstrative embodiments, the traffic class information may be utilized, for example, under a power save delivery framework, for example, an Unscheduled Automatic Power Save Delivery (U-APSD) framework, e.g., as described below.

In some demonstrative embodiments, a modified version of the Unscheduled Automatic Power Save Delivery (U-APSD) algorithm (“the U-APSD mechanism”) may be implemented, for example, to determine how devices of data group 129, exchange data during the DTxT, e.g., as described below.

Some demonstrative embodiments are described herein with respect to communicating during a timeblock using the U-APSD mechanism. However, in other embodiments, communication during the timeblock may use, or may be in accordance with any other mechanism, e.g., any other delivery mechanism, power save delivery mechanism, and the like.

In some demonstrative embodiments, a paged device of data group 129, e.g., device 140, may be allowed to send trigger frames during the DTxT, e.g., to different paging devices, to request for buffered data.

In some demonstrative embodiments, the paged device may send the trigger frames according to one or more WiFi MultiMedia (WMM) Power Save (WMM-PS) (also referred to as “U-APSD”) rules and/or any other rules of any other delivery mechanism, e.g., as described below.

In some demonstrative embodiments, the paged device may send the trigger frames, for example, to trigger transmission of data buffered for the paged device from the paging device.

In some demonstrative embodiments, a transmission time of a trigger frame, may depend, for example, on the class of data buffered for the paged device, e.g., as may be indicated from one or more, e.g., different, paging devices.

For example, a paged device, e.g., device 140, may transmit trigger frames to request data of a first, higher, priority class, e.g., voice data, indicated from one paging device, for example, before transmitting trigger frames to request data of a second, lower, priority class, e.g., best-effort data, indicated from another paging device.

In some demonstrative embodiments, for example, the paging device, e.g., device 102, may begin transmitting data to the paged device, for example, upon hearing the trigger frame.

In some demonstrative embodiments, for example, the paged device, e.g., device 140, may be configured to send a multicast frame to multiple paging devices simultaneously, e.g., to a plurality of paging devices, which have indicated that data of the same class type is pending transmission to the paged device.

In some demonstrative embodiments, two or more paging devices, e.g., all paging devices, which are indicated in the multicast frame may start contending simultaneously for transmission, e.g., after receiving the multicast trigger frame, e.g., as described below.

In some demonstrative embodiments, based on QoS information learnt from received paging messages, e.g., paging messages 200 (FIG. 2), a paged device, e.g., device 140, may send a trigger frame, e.g., a QoS-Null frame or any other frame, to one or more paging devices informing the paging devices that the paged device is ready to receive data from the paging devices.

In some demonstrative embodiments, the paged device, e.g., device 140, may receive during the NT multiple paging messages, e.g., paging messages 200 (FIG. 2), indicating traffic for the paged device, e.g., from multiple paging devices.

In some demonstrative embodiments, the paged device, e.g., device 140, may transmit trigger messages, e.g., during the DTxT, according to a trigger frame transmission mechanism, e.g., as described below.

In some demonstrative embodiments, the paged device, e.g., device 140, may be configured to transmit a first trigger frame, e.g., corresponding to a first paging message, indicating a highest priority traffic for the paged device, e.g., Video traffic. The first trigger frame may be followed by a second trigger message, e.g., corresponding to a next highest priority traffic of a second paging message, and so on.

In some demonstrative embodiments, device 140 may be configured to transmit trigger frames, e.g., in response to the paging messages, for example, according to the trigger frame transmission mechanism, e.g., as described above.

In some demonstrative embodiments, controller 154 may be configured to control, cause and/or trigger device 140 and/or transmitter 146 to transmit a first trigger message to trigger transmission of first data having a first priority, and, subsequent to the first trigger message, to transmit a second trigger message to trigger transmission of second data having a second priority, which is lower than the first priority.

In some demonstrative embodiments, controller 154 may be configured to control, cause and/or trigger device 140 and/or transmitter 146 to transmit a trigger message to trigger transmission of buffered traffic, e.g., all buffered traffic, from a paging device, e.g., device 102, for example to trigger transmission of buffered data at the paging device, which is buffered for device 140 and/or one or more other devices.

In some demonstrative embodiments, controller 154 may be configured to control, cause and/or trigger device 140 and/or transmitter 146 to transmit a first trigger message to trigger transmission of data from a first paging device having a first priority, and, subsequent to the first trigger message, to transmit a second trigger message to trigger transmission of data from a second paging device having a second priority, which is lower than the first priority.

In some demonstrative embodiments, controller 154 may be configured to control, cause and/or trigger device 140 and/or transmitter 146 to transmit at least one unicast trigger message to at least one respective paging device.

In some demonstrative embodiments, controller 154 may be configured to control, cause and/or trigger device 140 and/or transmitter 146 to transmit a multicast trigger message to two or more paging devices. In one example, the two or more paging devices may include devices from which paging messages indicate data of different class types is pending for device 140. In another example, the two or more paging devices comprise devices from which paging messages indicate data of a same class type is pending for device 140.

In some demonstrative embodiments, the transmission of the trigger frames according to the priority of the traffic for the paged device may be performed according to one or more trigger transmission mechanisms, e.g., as described below.

In some demonstrative embodiments, according to a first trigger transmission mechanism, at the beginning of the DTxT, a paged device, e.g., device 140, may start a backoff timer, e.g., a backoff timer similar to a backoff timer of an EDCA mechanism or any other backoff timer, for example, before transmitting the first trigger frame corresponding to the first paging message, e.g., that indicates the highest priority traffic for the paged device.

In some demonstrative embodiments, the paged device may start another backoff timer before transmitting the second trigger frame corresponding to the second paging message, e.g., that indicates the next highest priority traffic.

In some demonstrative embodiments, the paging device, e.g., device 140, may be configured to perform the trigger frame transmission, e.g., of the first and second trigger frames, for example, in accordance with one or more WMM-PS (U-APSD) and/or EDCA rules.

In some demonstrative embodiments, the backoff timer may be decided, for example, based on any traffic class defined in an EDCA parameter.

In some demonstrative embodiments, the backoff timer may be decided, for example, based on the traffic class indicated in the paging message.

In some demonstrative embodiments, the backoff timer may be a parameter defined by any other mechanism, e.g., other than the EDCA mechanism.

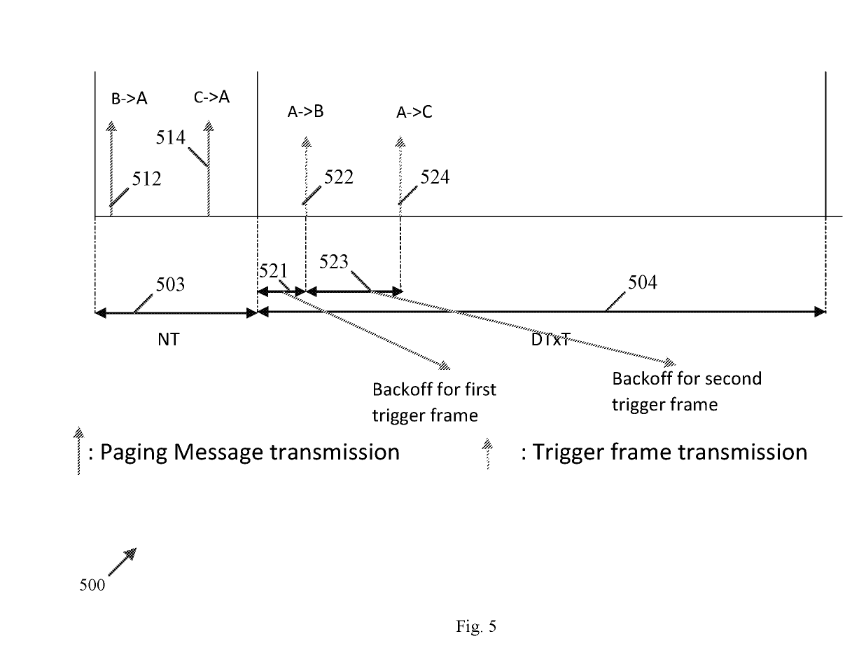

Reference is made to FIG. 5, which schematically illustrates communications between NAN devices according to a trigger frame transmission mechanism 500. For example, one or more of the NAN devices of data group 129 (FIG. 1) may communicate according to a trigger frame transmission mechanism 500.

In some demonstrative embodiments, trigger frame transmission mechanism 500 may be implemented according to the first trigger frame transmission mechanism, e.g., as described above.

In some demonstrative embodiments, as shown in FIG. 5, the communications between the NAN devices may be performed during a negotiation time (NT) 502 followed by a DTxT 504.

In some demonstrative embodiments, as shown in FIG. 5, during the NT 502 the NAN devices may transmit paging messages. For example, a first device, denoted B, may send a paging message 512 to a second device, denoted A, for example, to indicate to device A that device B has pending data to transmit to device A during the DTxT 504; and a third device, denoted C, may send a paging message 514 to the second device A, for example, to indicate to device A that device C has pending data to transmit to device A during the DTxT 504.

In one example, the symbol “->” denotes the direction of transmission. For example, “B->A” indicates transmission from device B to device A.

In some demonstrative embodiments, as shown in FIG. 5, device A may transmit a trigger frame transmission 522 to device B, e.g., after a backoff period 521, followed by a trigger frame transmission 524 to device “C”, e.g., after a backoff period 523.

In one example, the paging message 512 may indicate that device B has buffered data of a first class for the device A, e.g., voice data; and/or the paging message 514 from device C may indicate that device C has buffered data of a second class, which may have a lower priority than the priority of the first class, for the device A, e.g., best-effort data.

In some demonstrative embodiments, if the paged device, e.g., device A, receives multiple paging messages indicating buffered data of the same priority class, e.g., from devices B and C, then the device A may transmit corresponding trigger frames in the order of the paging message transmission time.

In other embodiments, any other additional or alternative “tie breaker” schemes may be used, e.g., when multiple paging messages indicating buffered data of the same priority class are received at the paged device.

Referring back to FIG. 1, in some demonstrative embodiments, the transmission of the trigger frames according to the priority of the traffic for the paged device may be performed according to a second trigger frame transmission mechanism, e.g., as described below.

In some demonstrative embodiments, according to the second trigger transmission mechanism, if a paged device, e.g., device 140, receives multiple paging messages indicating traffic for the paged device from multiple paging devices, then the paged device may transmit one or more multicast trigger frames to the multiple paging devices, e.g., to simultaneously inform the multiple paging devices that the paged device is ready to receive the traffic.

In some demonstrative embodiments, the multicast trigger frames may, for example, correspond to all paging messages received by the paged device and may indicate the same priority class of data pending for the paged device.

In some demonstrative embodiments, the paged device may use a back-off timer to contend to transmit the multicast trigger frames. For example, the backoff timer may be set, e.g., using one or more of the mechanisms described above with respect to the first trigger transmission mechanism.

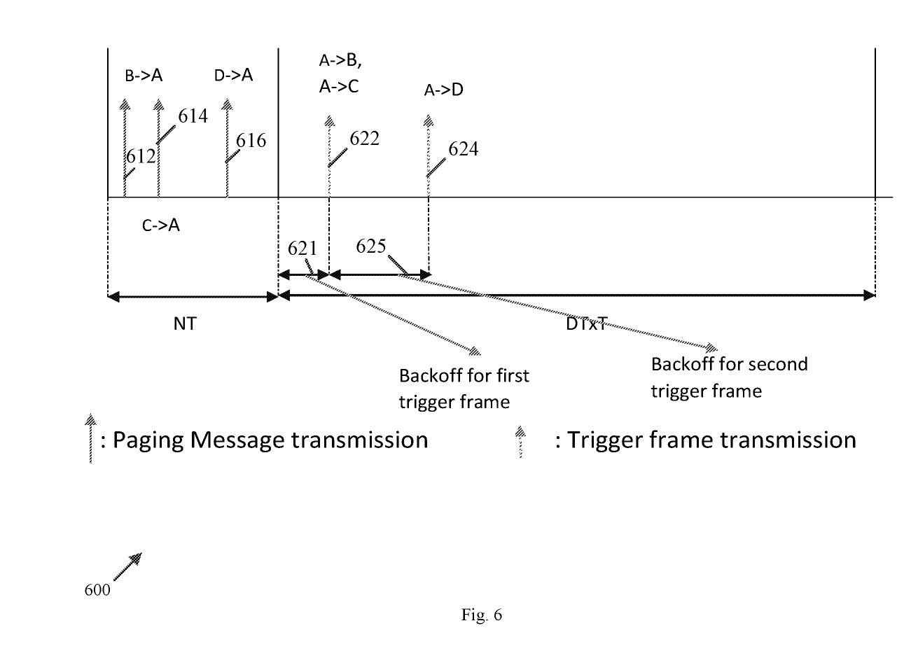

Reference is made to FIG. 6, which schematically illustrates communications between NAN devices according to a trigger frame transmission mechanism 600. For example, one or more of the NAN devices of data group 129 (FIG. 1) may communicate according to a trigger frame transmission mechanism 600.

In some demonstrative embodiments, trigger frame transmission mechanism 600 may be implemented according to the second trigger frame transmission mechanism, e.g., as described above.

In some demonstrative embodiments, as shown in FIG. 6, the communications between the NAN devices may be performed during a negotiation time (NT) 602 followed by a DTxT 604.

In some demonstrative embodiments, as shown in FIG. 6, during the NT 602 the NAN devices may transmit paging messages. For example, a first device, denoted B, may send a paging message 612 to a second device, denoted A, for example, to indicate to device A that device B has pending data to transmit to device A during the DTxT 504; a third device, denoted C, may send a paging message 614 to the second device A, for example, to indicate to device A that device C has pending data to transmit to device a during the DTxT 504; and/or a fourth device, denoted D, may send a paging message 616 to the second device A, for example, to indicate to device A that device D has pending data to transmit to device A during the DTxT 504.

In one example, the symbol “->” denotes the direction of transmission. For example, “B->A” indicates transmission from device B to device A.

In some demonstrative embodiments, as shown in FIG. 6, during the DTxT 604, device A may transmit a multicast trigger frame transmission 622 to both the devices B and C, e.g., after a backoff period 621.

In one example, the devices B and C both have data of a first priority, e.g., high priority voice data, buffered for the device A, while the device D may have data of a second priority, e.g., lower than the first priority, for example, low priority best-effort data, buffered for the device A.

In some demonstrative embodiments, as shown in FIG. 6, device A may transmit the multicast trigger frame 622 to both device B and device C, followed by another, e.g., unicast, trigger frame transmission 624 to the device D, e.g., after a backoff period 625.

In some demonstrative embodiments, the trigger frames, e.g., trigger frames 622 and/or 624, may be configured to correspond simply to all paging messages received by the device A.

In other embodiments, the device A may send a single multicast trigger frame to trigger transmission from all paging devices having data buffered for the device, e.g., to devices B, C and D. According to these embodiments, the device A may just use a single backoff timer.

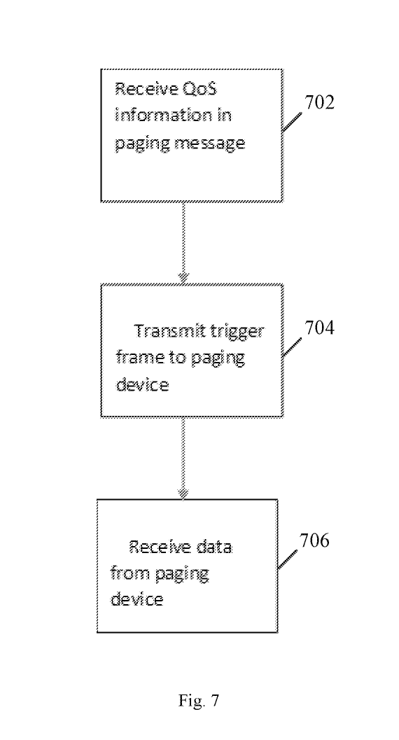

Reference is made to FIG. 7, which schematically illustrates a flow-chart illustration of a method of communicating during a timeblock, in accordance with some demonstrative embodiments. For example, one or more of the operations of the method of FIG. 7 may be performed by one or more elements of a system, system 100 (FIG. 1); a device, e.g., wireless communication devices 102, 140, 160 and/or 180 (FIG. 1); a controller, e.g., controller 124 (FIG. 1), and/or controller 154 (FIG. 1); a radio, e.g., radio 114 (FIG. 1); and/or radio 144 (FIG. 1); and/or a message processor, e.g., message processor 128 (FIG. 1) and/or message processor 158 (FIG. 1).

In some demonstrative embodiments, one or more of the operations of the method of FIG. 7 may be performed, for example, to exchange data during the DTxT, e.g., while ensuring QoS.

In some demonstrative embodiments, one or more of the operations of the method of FIG. 7 may be performed by a paged device, for example, to trigger a paging device to send buffered data to the paged device, e.g., as described below.

As indicated at block 702, the method may include receiving QoS information in at least one paging message, e.g., paging message 200 (FIG. 2), from at least one paging device. For example, device 140 (FIG. 1) may receive one or more paging messages 200 (FIG. 2) from device 102 (FIG. 1) and/or one or more other devices of data group 129 (FIG. 1), e.g., as described above.

In some demonstrative embodiments, during the NT, a device, e.g., each device, may transmit paging messages, for example, to all devices for which it has buffered data.

In some demonstrative embodiments, in addition to informing a paged device whether or not it has data, the paging device may also inform the paged device about the class of data buffered for it, for example, whether the buffered data is voice, best-effort, or of another class type, e.g., as described above.

In some demonstrative embodiments, the paging device may transmit to the paged device a paging message having a structure configured to carry the QoS information, e.g., as described above with respect to paging message 200 (FIG. 2).

As indicated at block 704, the method may include transmitting one or more trigger frames to one or more paging devices, e.g., based on the one or more received paging messages. For example, device 140 (FIG. 1) may transmit one or more trigger messages to one or more paging devices from which device 140 (FIG. 1) received paging messages indicating pending data for device 140 (FIG. 1), e.g., as described above.

In some demonstrative embodiments, based on the QoS information learnt from received paging messages, a paged device, e.g., each paged device, may send a trigger frame, e.g., a QoS-Null frame or any other frame, to one or more paging devices informing the paging devices that the paged device is ready to receive data from the paging devices, e.g., as described above.

As indicated at block 706, the method may include receiving data from the one or more paging devices, e.g., based on the one or more trigger frames.

In some demonstrative embodiments, upon receiving a trigger frame, a paging device may begin transmitting buffered data to the sender of the trigger frame, for example, after a fixed time, e.g., a Short Inter Frame Space (SIFS), or any other period, for example, if the received trigger frame is a unicast trigger frame. For example, device 102 (FIG. 1) may send buffered data to device 140 (FIG. 1), for example, based on a trigger message received from device 140 (FIG. 1), e.g., as described above.

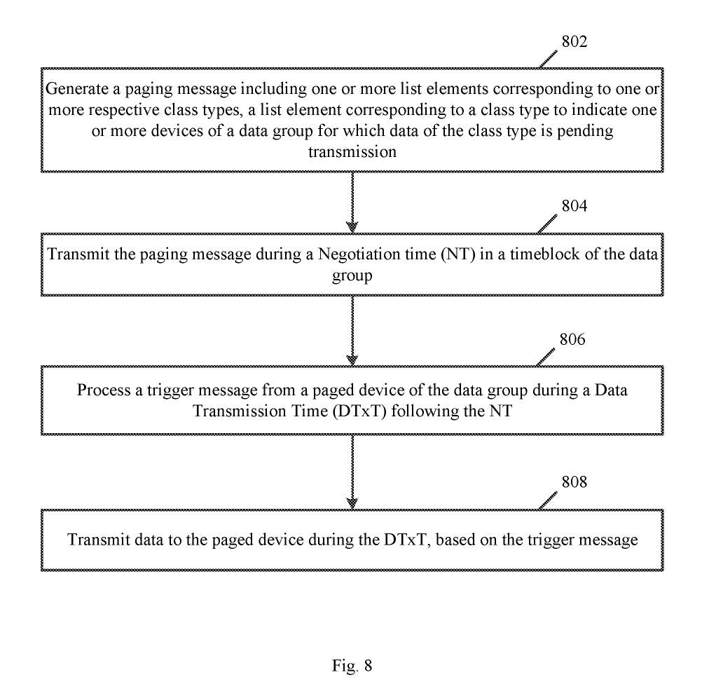

Reference is made to FIG. 8, which schematically illustrates a method of communicating in a data group, in accordance with some demonstrative embodiments. For example, one or more of the operations of the method of FIG. 8 may be performed by one or more elements of a system, system 100 (FIG. 1); a paging device, e.g., wireless communication device 102 (FIG. 1); a controller, e.g., controller 124 (FIG. 1); a radio, e.g., radio 114 (FIG. 1); and/or a message processor, e.g., message processor 128 (FIG. 1).

As indicated at block 802, the method may include generating a paging message including one or more list elements corresponding to one or more class types, a list element corresponding to a class type to indicate one or more devices of a data group for which data of the class type is pending transmission. For example, controller 124 (FIG. 1) may control, cause and/or trigger device 102 (FIG. 1) to generate the paging message 200 (FIG. 2), e.g., as described above.

As indicated at block 804, the method may include transmitting the paging message during a Negotiation time (NT) in a timeblock of the data group. For example, controller 124 (FIG. 1) may control, cause and/or trigger device 102 (FIG. 1) to transmit the paging message during the NT in the timeblock of the data group 129 (FIG. 1), e.g., as described above.

As indicated at block 806, the method may include processing a trigger message from a paged device of the data group during a DTxT following the NT. For example, controller 124 (FIG. 1) may control, cause and/or trigger device 102 (FIG. 1) to process a trigger message from device 140 (FIG. 1) of the data group 129 (FIG. 1) during the DTxT following the NT, e.g., as described above.

As indicated at block 808, the method may include transmitting data to the paged device during the DTxT, for example, based on the trigger message. For example, controller 124 (FIG. 1) may control, cause and/or trigger device 102 (FIG. 1) to transmit data to device 140 (FIG. 1) during the DTxT, for example, based on the trigger message from device 140 (FIG. 1), e.g., as described above.

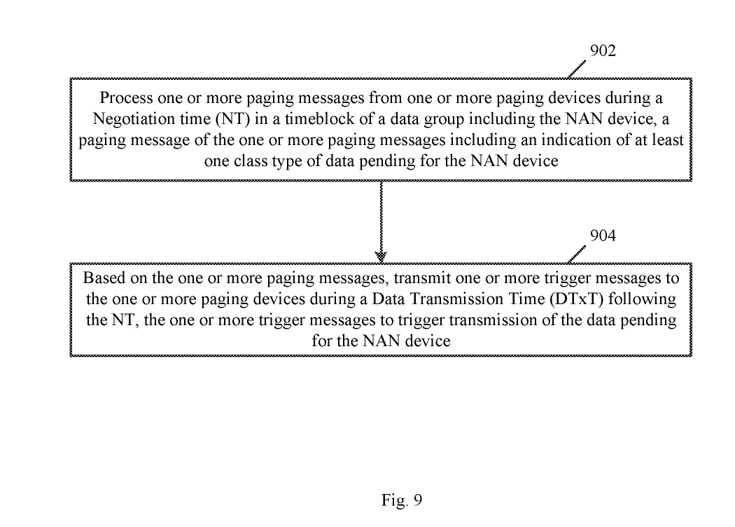

Reference is made to FIG. 9, which schematically illustrates a method of communicating in a data group, in accordance with some demonstrative embodiments. For example, one or more of the operations of the method of FIG. 9 may be performed by one or more elements of a system, system 100 (FIG. 1); a paged device, e.g., wireless communication device 140 (FIG. 1); a controller, e.g., controller 154 (FIG. 1); a radio, e.g., radio 154 (FIG. 1); and/or a message processor, e.g., message processor 158 (FIG. 1).

As indicated at block 902, the method may include processing one or more paging messages from one or more paging devices during an NT in a timeblock of a data group including the NAN device, a paging message of the one or more paging messages including an indication of at least one class type of data pending for the NAN device. For example, controller 154 (FIG. 1) may control, cause and/or trigger device 140 (FIG. 1) to process the one or more paging messages from the one or more paging devices during the NT in the timeblock of data group 129 (FIG. 1), e.g., as described above.

As indicated at block 904, the method may include, based on the one or more paging messages, transmitting one or more trigger messages to the one or more paging devices during a DTxT following the NT, the one or more trigger messages to trigger transmission of the data pending for the NAN device. For example, controller 154 (FIG. 1) may control, cause and/or trigger device 140 (FIG. 1) to transmit the one or more trigger messages to the one or more paging devices of data group 129 (FIG. 1) during the DTxT following the NT timeblock of the data group 129 (FIG. 1), for example, based on the one or more paging messages, e.g., as described above.

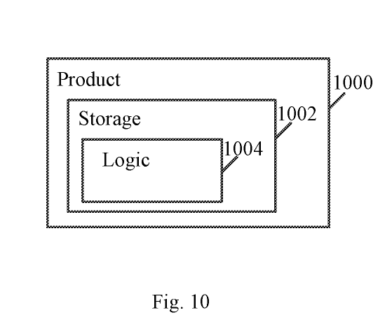

Reference is made to FIG. 10, which schematically illustrates a product of manufacture 1000, in accordance with some demonstrative embodiments. Product 1000 may include one or more tangible computer-readable non-transitory storage media 1002, which may include computer-executable instructions, e.g., implemented by logic 1004, operable to, when executed by at least one computer processor, enable the at least one computer processor to implement one or more operations at device 102, device 140, device 160 and/or device 180 (FIG. 1), radio 114 (FIG. 1), transmitter 118 (FIG. 1), receiver 116 (FIG. 1), controller 124, controller 154 (FIG. 1), message processor 128 (FIG. 1), message processor 158 (FIG. 1), and/or to perform, trigger and/or implement one or more operations and/or functionalities described above with respect to one or more of the FIGS. 1-9, and/or one or more operations described herein. The phrase “non-transitory machine-readable medium” is directed to include all computer-readable media, with the sole exception being a transitory propagating signal.

In some demonstrative embodiments, product 1000 and/or machine-readable storage medium 1002 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising logic and circuitry configured to cause a Neighbor Awareness Networking (NAN) device to generate a paging message comprising one or more list elements corresponding to one or more class types, a list element corresponding to a class type to indicate one or more devices of a data group for which data of the class type is pending transmission; transmit the paging message during a Negotiation time (NT) in a timeblock of the data group; process a trigger message from a paged device of the data group during a Data Transmission Time (DTxT) following the NT; and based on the trigger message, transmit data to the paged device during the DTxT.

Example 2 includes the subject matter of Example 1, and optionally, wherein the one or more list elements comprise at least a multicast list element to indicate one or more devices for which multicast data is pending.

Example 3 includes the subject matter of Example 1 or 2, and optionally, wherein the one or more list elements comprise at least a unicast list element to indicate one or more devices for which unicast data is pending.

Example 4 includes the subject matter of any one of Examples 1-3, and optionally, wherein the apparatus is configured to cause the NAN device to include an indication of a device of the data group only in a list element corresponding to a class type of a highest priority for which data is pending transmission to the device of the data group.

Example 5 includes the subject matter of any one of Examples 1-4, and optionally, wherein the one or more list elements comprise at least four list elements corresponding to at least four respective class types.

Example 6 includes the subject matter of Example 5, and optionally, wherein the at least four list elements comprise at least a Video (VI) list element, a Voice (VO) list element, a best Effort (BE) list element, and a Background (BK) list element.

Example 7 includes the subject matter of any one of Examples 1-6, and optionally, wherein the trigger message comprises a Quality of Service (QoS) Null frame.

Example 8 includes the subject matter of any one of Examples 1-7, and optionally, wherein the apparatus is configured to cause the NAN device to determine one or more parameters of a contention window based at least on a class type of the data to be transmitted to the paged device, and to contend to transmit the data to the paged device during the contention window.

Example 9 includes the subject matter of any one of Examples 1-8, and optionally, wherein the list element corresponding to the class type comprises one or more identifiers of the one or more devices of the data group for which data of the class type is pending transmission.

Example 10 includes the subject matter of any one of Examples 1-8, and optionally, wherein the trigger message comprises a unicast trigger message from the paged device to the NAN device.

Example 11 includes the subject matter of any one of Examples 1-8, and optionally, wherein the trigger message comprises a multicast trigger message from the paged device to a plurality of NAN devices comprising the NAN device.

Example 12 includes the subject matter of any one of Examples 1-11, and optionally, comprising a radio to transmit the paging message, to receive the trigger message, and to transmit the data to the paged device.

Example 13 includes the subject matter of any one of Examples 1-12, and optionally, comprising a memory, a processor, and one or more antennas.

Example 14 includes a system of wireless communication comprising a Neighbor Awareness Networking (NAN) device, the NAN device comprising one or more antennas; a memory; a processor; a radio; and a controller configured to cause the NAN device to generate a paging message comprising one or more list elements corresponding to one or more class types, a list element corresponding to a class type to indicate one or more devices of a data group for which data of the class type is pending transmission; transmit the paging message during a Negotiation time (NT) in a timeblock of the data group; process a trigger message from a paged device of the data group during a Data Transmission Time (DTxT) following the NT; and based on the trigger message, transmit data to the paged device during the DTxT.

Example 15 includes the subject matter of Example 14, and optionally, wherein the one or more list elements comprise at least a multicast list element to indicate one or more devices for which multicast data is pending.

Example 16 includes the subject matter of Example 14 or 15, and optionally, wherein the one or more list elements comprise at least a unicast list element to indicate one or more devices for which unicast data is pending.

Example 17 includes the subject matter of any one of Examples 14-16, and optionally, wherein the NAN device is to include an indication of a device of the data group only in a list element corresponding to a class type of a highest priority for which data is pending transmission to the device of the data group.

Example 18 includes the subject matter of any one of Examples 14-17, and optionally, wherein the one or more list elements comprise at least four list elements corresponding to at least four respective class types.

Example 19 includes the subject matter of Example 18, and optionally, wherein the at least four list elements comprise at least a Video (VI) list element, a Voice (VO) list element, a best Effort (BE) list element, and a Background (BK) list element.

Example 20 includes the subject matter of any one of Examples 14-19, and optionally, wherein the trigger message comprises a Quality of Service (QoS) Null frame.

Example 21 includes the subject matter of any one of Examples 14-20, and optionally, wherein the NAN device is to determine one or more parameters of a contention window based at least on a class type of the data to be transmitted to the paged device, and to contend to transmit the data to the paged device during the contention window.

Example 22 includes the subject matter of any one of Examples 14-21, and optionally, wherein the list element corresponding to the class type comprises one or more identifiers of the one or more devices of the data group for which data of the class type is pending transmission.

Example 23 includes the subject matter of any one of Examples 14-21, and optionally, wherein the trigger message comprises a unicast trigger message from the paged device to the NAN device.

Example 24 includes the subject matter of any one of Examples 14-21, and optionally, wherein the trigger message comprises a multicast trigger message from the paged device to a plurality of NAN devices comprising the NAN device.

Example 25 includes a method to be performed at a Neighbor Awareness Networking (NAN) device, the method comprising generating a paging message comprising one or more list elements corresponding to one or more class types, a list element corresponding to a class type to indicate one or more devices of a data group for which data of the class type is pending transmission; transmitting the paging message during a Negotiation time (NT) in a timeblock of the data group; processing a trigger message from a paged device of the data group during a Data Transmission Time (DTxT) following the NT; and based on the trigger message, transmitting data to the paged device during the DTxT.

Example 26 includes the subject matter of Example 25, and optionally, wherein the one or more list elements comprise at least a multicast list element to indicate one or more devices for which multicast data is pending.

Example 27 includes the subject matter of Example 25 or 26, and optionally, wherein the one or more list elements comprise at least a unicast list element to indicate one or more devices for which unicast data is pending.

Example 28 includes the subject matter of any one of Examples 25-27, and optionally, comprising including an indication of a device of the data group only in a list element corresponding to a class type of a highest priority for which data is pending transmission to the device of the data group.

Example 29 includes the subject matter of any one of Examples 25-28, and optionally, wherein the one or more list elements comprise at least four list elements corresponding to at least four respective class types.

Example 30 includes the subject matter of Example 29, and optionally, wherein the at least four list elements comprise at least a Video (VI) list element, a Voice (VO) list element, a best Effort (BE) list element, and a Background (BK) list element.

Example 31 includes the subject matter of any one of Examples 25-30, and optionally, wherein the trigger message comprises a Quality of Service (QoS) Null frame.

Example 32 includes the subject matter of any one of Examples 25-31, and optionally, comprising determining one or more parameters of a contention window based at least on a class type of the data to be transmitted to the paged device, and contending to transmit the data to the paged device during the contention window.

Example 33 includes the subject matter of any one of Examples 25-32, and optionally, wherein the list element corresponding to the class type comprises one or more identifiers of the one or more devices of the data group for which data of the class type is pending transmission.

Example 34 includes the subject matter of any one of Examples 25-32, and optionally, wherein the trigger message comprises a unicast trigger message from the paged device to the NAN device.

Example 35 includes the subject matter of any one of Examples 25-32, and optionally, wherein the trigger message comprises a multicast trigger message from the paged device to a plurality of NAN devices comprising the NAN device.

Example 36 includes a product comprising one or more tangible computer-readable non-transitory storage media comprising computer-executable instructions operable to, when executed by at least one computer processor, enable the at least one computer processor to implement operations at a Neighbor Awareness Networking (NAN) device, the operations comprising generating a paging message comprising one or more list elements corresponding to one or more class types, a list element corresponding to a class type to indicate one or more devices of a data group for which data of the class type is pending transmission; transmitting the paging message during a Negotiation time (NT) in a timeblock of the data group; processing a trigger message from a paged device of the data group during a Data Transmission Time (DTxT) following the NT; and based on the trigger message, transmitting data to the paged device during the DTxT.

Example 37 includes the subject matter of Example 36, and optionally, wherein the one or more list elements comprise at least a multicast list element to indicate one or more devices for which multicast data is pending.

Example 38 includes the subject matter of Example 36 or 37, and optionally, wherein the one or more list elements comprise at least a unicast list element to indicate one or more devices for which unicast data is pending.

Example 39 includes the subject matter of any one of Examples 36-38, and optionally, wherein the operations comprise including an indication of a device of the data group only in a list element corresponding to a class type of a highest priority for which data is pending transmission to the device of the data group.

Example 40 includes the subject matter of any one of Examples 36-39, and optionally, wherein the one or more list elements comprise at least four list elements corresponding to at least four respective class types.

Example 41 includes the subject matter of Example 40, and optionally, wherein the at least four list elements comprise at least a Video (VI) list element, a Voice (VO) list element, a best Effort (BE) list element, and a Background (BK) list element.

Example 42 includes the subject matter of any one of Examples 36-41, and optionally, wherein the trigger message comprises a Quality of Service (QoS) Null frame.

Example 43 includes the subject matter of any one of Examples 36-42, and optionally, wherein the operations comprise determining one or more parameters of a contention window based at least on a class type of the data to be transmitted to the paged device, and contending to transmit the data to the paged device during the contention window.

Example 44 includes the subject matter of any one of Examples 36-43, and optionally, wherein the list element corresponding to the class type comprises one or more identifiers of the one or more devices of the data group for which data of the class type is pending transmission.

Example 45 includes the subject matter of any one of Examples 36-43, and optionally, wherein the trigger message comprises a unicast trigger message from the paged device to the NAN device.

Example 46 includes the subject matter of any one of Examples 36-43, and optionally, wherein the trigger message comprises a multicast trigger message from the paged device to a plurality of NAN devices comprising the NAN device.

Example 47 includes an apparatus of wireless communication by a Neighbor Awareness Networking (NAN) device, the apparatus comprising means for generating a paging message comprising one or more list elements corresponding to one or more class types, a list element corresponding to a class type to indicate one or more devices of a data group for which data of the class type is pending transmission; means for transmitting the paging message during a Negotiation time (NT) in a timeblock of the data group; means for processing a trigger message from a paged device of the data group during a Data Transmission Time (DTxT) following the NT; and means for, based on the trigger message, transmitting data to the paged device during the DTxT.

Example 48 includes the subject matter of Example 47, and optionally, wherein the one or more list elements comprise at least a multicast list element to indicate one or more devices for which multicast data is pending.

Example 49 includes the subject matter of Example 47 or 48, and optionally, wherein the one or more list elements comprise at least a unicast list element to indicate one or more devices for which unicast data is pending.

Example 50 includes the subject matter of any one of Examples 47-49, and optionally, comprising means for including an indication of a device of the data group only in a list element corresponding to a class type of a highest priority for which data is pending transmission to the device of the data group.

Example 51 includes the subject matter of any one of Examples 47-50, and optionally, wherein the one or more list elements comprise at least four list elements corresponding to at least four respective class types.

Example 52 includes the subject matter of Example 51, and optionally, wherein the at least four list elements comprise at least a Video (VI) list element, a Voice (VO) list element, a best Effort (BE) list element, and a Background (BK) list element.

Example 53 includes the subject matter of any one of Examples 47-52, and optionally, wherein the trigger message comprises a Quality of Service (QoS) Null frame.

Example 54 includes the subject matter of any one of Examples 47-53, and optionally, comprising means for determining one or more parameters of a contention window based at least on a class type of the data to be transmitted to the paged device, and contending to transmit the data to the paged device during the contention window.

Example 55 includes the subject matter of any one of Examples 47-54, and optionally, wherein the list element corresponding to the class type comprises one or more identifiers of the one or more devices of the data group for which data of the class type is pending transmission.

Example 56 includes the subject matter of any one of Examples 47-54, and optionally, wherein the trigger message comprises a unicast trigger message from the paged device to the NAN device.

Example 57 includes the subject matter of any one of Examples 47-54, and optionally, wherein the trigger message comprises a multicast trigger message from the paged device to a plurality of NAN devices comprising the NAN device.

Example 58 includes an apparatus comprising logic and circuitry configured to cause a Neighbor Awareness Networking (NAN) device to process one or more paging messages from one or more paging devices during a Negotiation time (NT) in a timeblock of a data group including the NAN device, a paging message of the one or more paging messages comprising an indication of at least one class type of data pending for the NAN device; and based on the one or more paging messages, transmit one or more trigger messages to the one or more paging devices during a Data Transmission Time (DTxT) following the NT, the one or more trigger messages to trigger transmission of the data pending for the NAN device.

Example 59 includes the subject matter of Example 58, and optionally, wherein the apparatus is configured to cause the NAN device to transmit a trigger message to trigger transmission of buffered traffic from a paging device.

Example 60 includes the subject matter of Example 58 or 59, and optionally, wherein the apparatus is configured to cause the NAN device to transmit a first trigger message to trigger transmission of data from a first paging device having a first priority, and, subsequent to the first trigger message, to transmit a second trigger message to trigger transmission of data from a second paging device having a second priority, which is lower than the first priority.

Example 61 includes the subject matter of any one of Examples 58-60, and optionally, wherein the apparatus is configured to cause the NAN device to transmit a first trigger message to trigger transmission of first data having a first priority, and, subsequent to the first trigger message, to transmit a second trigger message to trigger transmission of second data having a second priority, which is lower than the first priority.

Example 62 includes the subject matter of any one of Examples 58-61, and optionally, wherein the one or more trigger messages comprise at least one unicast trigger message to at least one respective paging device.

Example 63 includes the subject matter of any one of Examples 58-62, and optionally, wherein the apparatus is configured to cause the NAN device to transmit a multicast trigger message to two or more paging devices.

Example 64 includes the subject matter of Example 63, and optionally, wherein the two or more paging devices comprise devices from which paging messages indicate data of different class types is pending for the NAN device.

Example 65 includes the subject matter of Example 63, and optionally, wherein the two or more paging devices comprise devices from which paging messages indicate data of a same class type is pending for the NAN device.

Example 66 includes the subject matter of any one of Examples 58-65, and optionally, wherein the apparatus is configured to cause the NAN device to determine one or more parameters of a contention window corresponding to the class type of the data pending for the NAN device, and to contend to transmit a trigger message during the contention window, the trigger message to request transmission of the data of the class type pending for the NAN device.

Example 67 includes the subject matter of Example 66, and optionally, wherein the apparatus is configured to cause the NAN device to determine a beginning of the contention window based on a timing of the paging message.

Example 68 includes the subject matter of Example 67, and optionally, wherein the apparatus is configured to cause the NAN device to select an interval from a predefined number of intervals in the DTxT based on the timing of the paging message, and to begin the contention window at a beginning of the interval.

Example 69 includes the subject matter of Example 66, and optionally, wherein the apparatus is configured to cause the NAN device to determine a beginning of the contention window based on a number of paging messages, which are received prior to the paging message, and which indicate a same class type as the class type of the data pending for the NAN device.

Example 70 includes the subject matter of any one of Examples 66-69, and optionally, wherein the apparatus is configured to cause the NAN device to determine a duration of the contention window based on a priority of the class type of the data pending for the NAN device.

Example 71 includes the subject matter of any one of Examples 58-70, and optionally, wherein the paging message comprises one or more list elements corresponding to one or more class types, a list element corresponding to a class type indicating one or more devices of the data group for which data of the class type is pending transmission.

Example 72 includes the subject matter of Example 71, and optionally, wherein the one or more list elements comprise at least a multicast list element to indicate one or more devices for which multicast data is pending.

Example 73 includes the subject matter of Example 71 or 72, and optionally, wherein the one or more list elements comprise at least a unicast list element to indicate one or more devices for which unicast data is pending.

Example 74 includes the subject matter of any one of Examples 71-73, and optionally, wherein the one or more list elements comprise at least four list elements corresponding to at least four respective class types.

Example 75 includes the subject matter of Example 74, and optionally, wherein the at least four list elements comprise at least a Video (VI) list element, a Voice (VO) list element, a best Effort (BE) list element, and a Background (BK) list element.

Example 76 includes the subject matter of any one of Examples 58-75, and optionally, wherein the one or more trigger messages comprise a Quality of Service (QoS) Null frame.

Example 77 includes the subject matter of any one of Examples 58-76, and optionally, comprising a radio to receive the one or more paging messages, and to transmit the one or more trigger messages.

Example 78 includes the subject matter of any one of Examples 58-77, and optionally, comprising a memory, a processor, and one or more antennas.

Example 79 includes a system of wireless communication comprising a Neighbor Awareness Networking (NAN) device, the NAN device comprising one or more antennas; a memory; a processor; a radio; and a controller configured to cause the NAN device to process one or more paging messages from one or more paging devices during a Negotiation time (NT) in a timeblock of a data group including the NAN device, a paging message of the one or more paging messages comprising an indication of at least one class type of data pending for the NAN device; and based on the one or more paging messages, transmit one or more trigger messages to the one or more paging devices during a Data Transmission Time (DTxT) following the NT, the one or more trigger messages to trigger transmission of the data pending for the NAN device.

Example 80 includes the subject matter of Example 79, and optionally, wherein the NAN device is to transmit a trigger message to trigger transmission of buffered traffic from a paging device.

Example 81 includes the subject matter of Example 79 or 80, and optionally, wherein the NAN device is to transmit a first trigger message to trigger transmission of data from a first paging device having a first priority, and, subsequent to the first trigger message, to transmit a second trigger message to trigger transmission of data from a second paging device having a second priority, which is lower than the first priority.

Example 82 includes the subject matter of any one of Examples 79-81, and optionally, wherein the NAN device is to transmit a first trigger message to trigger transmission of first data having a first priority, and, subsequent to the first trigger message, to transmit a second trigger message to trigger transmission of second data having a second priority, which is lower than the first priority.

Example 83 includes the subject matter of any one of Examples 79-82, and optionally, wherein the one or more trigger messages comprise at least one unicast trigger message to at least one respective paging device.

Example 84 includes the subject matter of any one of Examples 79-83, and optionally, wherein the NAN device is to transmit a multicast trigger message to two or more paging devices.

Example 85 includes the subject matter of Example 84, and optionally, wherein the two or more paging devices comprise devices from which paging messages indicate data of different class types is pending for the NAN device.

Example 86 includes the subject matter of Example 84, and optionally, wherein the two or more paging devices comprise devices from which paging messages indicate data of a same class type is pending for the NAN device.

Example 87 includes the subject matter of any one of Examples 79-86, and optionally, wherein the NAN device is to determine one or more parameters of a contention window corresponding to the class type of the data pending for the NAN device, and to contend to transmit a trigger message during the contention window, the trigger message to request transmission of the data of the class type pending for the NAN device.

Example 88 includes the subject matter of Example 87, and optionally, wherein the NAN device is to determine a beginning of the contention window based on a timing of the paging message.

Example 89 includes the subject matter of Example 88, and optionally, wherein the NAN device is to select an interval from a predefined number of intervals in the DTxT based on the timing of the paging message, and to begin the contention window at a beginning of the interval.

Example 90 includes the subject matter of Example 87, and optionally, wherein the NAN device is to determine a beginning of the contention window based on a number of paging messages, which are received prior to the paging message, and which indicate a same class type as the class type of the data pending for the NAN device.

Example 91 includes the subject matter of any one of Examples 87-90, and optionally, wherein the NAN device is to determine a duration of the contention window based on a priority of the class type of the data pending for the NAN device.

Example 92 includes the subject matter of any one of Examples 79-91, and optionally, wherein the paging message comprises one or more list elements corresponding to one or more class types, a list element corresponding to a class type indicating one or more devices of the data group for which data of the class type is pending transmission.

Example 93 includes the subject matter of Example 92, and optionally, wherein the one or more list elements comprise at least a multicast list element to indicate one or more devices for which multicast data is pending.

Example 94 includes the subject matter of Example 92 or 93, and optionally, wherein the one or more list elements comprise at least a unicast list element to indicate one or more devices for which unicast data is pending.

Example 95 includes the subject matter of any one of Examples 92-94, and optionally, wherein the one or more list elements comprise at least four list elements corresponding to at least four respective class types.

Example 96 includes the subject matter of Example 95, and optionally, wherein the at least four list elements comprise at least a Video (VI) list element, a Voice (VO) list element, a best Effort (BE) list element, and a Background (BK) list element.

Example 97 includes the subject matter of any one of Examples 79-96, and optionally, wherein the one or more trigger messages comprise a Quality of Service (QoS) Null frame.

Example 98 includes a method to be performed at a Neighbor Awareness Networking (NAN) device, the method comprising processing one or more paging messages from one or more paging devices during a Negotiation time (NT) in a timeblock of a data group including the NAN device, a paging message of the one or more paging messages comprising an indication of at least one class type of data pending for the NAN device; and based on the one or more paging messages, transmitting one or more trigger messages to the one or more paging devices during a Data Transmission Time (DTxT) following the NT, the one or more trigger messages to trigger transmission of the data pending for the NAN device.

Example 99 includes the subject matter of Example 98, and optionally, comprising transmitting a trigger message to trigger transmission of buffered traffic from a paging device.

Example 100 includes the subject matter of Example 98 or 99, and optionally, comprising transmitting a first trigger message to trigger transmission of data from a first paging device having a first priority, and, subsequent to the first trigger message, transmitting a second trigger message to trigger transmission of data from a second paging device having a second priority, which is lower than the first priority.

Example 101 includes the subject matter of any one of Examples 98-100, and optionally, comprising transmitting a first trigger message to trigger transmission of first data having a first priority, and, subsequent to the first trigger message, transmitting a second trigger message to trigger transmission of second data having a second priority, which is lower than the first priority.

Example 102 includes the subject matter of any one of Examples 98-101, and optionally, wherein the one or more trigger messages comprise at least one unicast trigger message to at least one respective paging device.

Example 103 includes the subject matter of any one of Examples 98-102, and optionally, comprising transmitting a multicast trigger message to two or more paging devices.

Example 104 includes the subject matter of Example 103, and optionally, wherein the two or more paging devices comprise devices from which paging messages indicate data of different class types is pending for the NAN device.

Example 105 includes the subject matter of Example 103, and optionally, wherein the two or more paging devices comprise devices from which paging messages indicate data of a same class type is pending for the NAN device.

Example 106 includes the subject matter of any one of Examples 98-105, and optionally, comprising determining one or more parameters of a contention window corresponding to the class type of the data pending for the NAN device, and contending to transmit a trigger message during the contention window, the trigger message to request transmission of the data of the class type pending for the NAN device.

Example 107 includes the subject matter of Example 106, and optionally, comprising determining a beginning of the contention window based on a timing of the paging message.

Example 108 includes the subject matter of Example 107, and optionally, comprising selecting an interval from a predefined number of intervals in the DTxT based on the timing of the paging message, and beginning the contention window at a beginning of the interval.

Example 109 includes the subject matter of Example 106, and optionally, comprising determining a beginning of the contention window based on a number of paging messages, which are received prior to the paging message, and which indicate a same class type as the class type of the data pending for the NAN device.

Example 110 includes the subject matter of any one of Examples 106-109, and optionally, comprising determining a duration of the contention window based on a priority of the class type of the data pending for the NAN device.

Example 111 includes the subject matter of any one of Examples 98-110, and optionally, wherein the paging message comprises one or more list elements corresponding to one or more class types, a list element corresponding to a class type indicating one or more devices of the data group for which data of the class type is pending transmission.

Example 112 includes the subject matter of Example 111, and optionally, wherein the one or more list elements comprise at least a multicast list element to indicate one or more devices for which multicast data is pending.

Example 113 includes the subject matter of Example 111 or 112, and optionally, wherein the one or more list elements comprise at least a unicast list element to indicate one or more devices for which unicast data is pending.

Example 114 includes the subject matter of any one of Examples 111-113, and optionally, wherein the one or more list elements comprise at least four list elements corresponding to at least four respective class types.

Example 115 includes the subject matter of Example 114, and optionally, wherein the at least four list elements comprise at least a Video (VI) list element, a Voice (VO) list element, a best Effort (BE) list element, and a Background (BK) list element.

Example 116 includes the subject matter of any one of Examples 98-115, and optionally, wherein the one or more trigger messages comprise a Quality of Service (QoS) Null frame.

Example 117 includes a product comprising one or more tangible computer-readable non-transitory storage media comprising computer-executable instructions operable to, when executed by at least one computer processor, enable the at least one computer processor to implement operations at a Neighbor Awareness Networking (NAN) device, the operations comprising processing one or more paging messages from one or more paging devices during a Negotiation time (NT) in a timeblock of a data group including the NAN device, a paging message of the one or more paging messages comprising an indication of at least one class type of data pending for the NAN device; and based on the one or more paging messages, transmitting one or more trigger messages to the one or more paging devices during a Data Transmission Time (DTxT) following the NT, the one or more trigger messages to trigger transmission of the data pending for the NAN device.

Example 118 includes the subject matter of Example 117, and optionally, wherein the operations comprise transmitting a trigger message to trigger transmission of buffered traffic from a paging device.

Example 119 includes the subject matter of Example 117 or 118, and optionally, wherein the operations comprise transmitting a first trigger message to trigger transmission of data from a first paging device having a first priority, and, subsequent to the first trigger message, transmitting a second trigger message to trigger transmission of data from a second paging device having a second priority, which is lower than the first priority.

Example 120 includes the subject matter of any one of Examples 117-119, and optionally, wherein the operations comprise transmitting a first trigger message to trigger transmission of first data having a first priority, and, subsequent to the first trigger message, transmitting a second trigger message to trigger transmission of second data having a second priority, which is lower than the first priority.

Example 121 includes the subject matter of any one of Examples 117-120, and optionally, wherein the one or more trigger messages comprise at least one unicast trigger message to at least one respective paging device.

Example 122 includes the subject matter of any one of Examples 117-121, and optionally, wherein the operations comprise transmitting a multicast trigger message to two or more paging devices.

Example 123 includes the subject matter of Example 122, and optionally, wherein the two or more paging devices comprise devices from which paging messages indicate data of different class types is pending for the NAN device.

Example 124 includes the subject matter of Example 122, and optionally, wherein the two or more paging devices comprise devices from which paging messages indicate data of a same class type is pending for the NAN device.

Example 125 includes the subject matter of any one of Examples 117-124, and optionally, wherein the operations comprise determining one or more parameters of a contention window corresponding to the class type of the data pending for the NAN device, and contending to transmit a trigger message during the contention window, the trigger message to request transmission of the data of the class type pending for the NAN device.

Example 126 includes the subject matter of Example 125, and optionally, wherein the operations comprise determining a beginning of the contention window based on a timing of the paging message.

Example 127 includes the subject matter of Example 126, and optionally, wherein the operations comprise selecting an interval from a predefined number of intervals in the DTxT based on the timing of the paging message, and beginning the contention window at a beginning of the interval.

Example 128 includes the subject matter of Example 125, and optionally, wherein the operations comprise determining a beginning of the contention window based on a number of paging messages, which are received prior to the paging message, and which indicate a same class type as the class type of the data pending for the NAN device.

Example 129 includes the subject matter of any one of Examples 125-128, and optionally, wherein the operations comprise determining a duration of the contention window based on a priority of the class type of the data pending for the NAN device.

Example 130 includes the subject matter of any one of Examples 117-129, and optionally, wherein the paging message comprises one or more list elements corresponding to one or more class types, a list element corresponding to a class type indicating one or more devices of the data group for which data of the class type is pending transmission.

Example 131 includes the subject matter of Example 130, and optionally, wherein the one or more list elements comprise at least a multicast list element to indicate one or more devices for which multicast data is pending.

Example 132 includes the subject matter of Example 130 or 131, and optionally, wherein the one or more list elements comprise at least a unicast list element to indicate one or more devices for which unicast data is pending.

Example 133 includes the subject matter of any one of Examples 130-132, and optionally, wherein the one or more list elements comprise at least four list elements corresponding to at least four respective class types.

Example 134 includes the subject matter of Example 133, and optionally, wherein the at least four list elements comprise at least a Video (VI) list element, a Voice (VO) list element, a best Effort (BE) list element, and a Background (BK) list element.

Example 135 includes the subject matter of any one of Examples 117-134, and optionally, wherein the one or more trigger messages comprise a Quality of Service (QoS) Null frame.

Example 136 includes an apparatus of wireless communication by a Neighbor Awareness Networking (NAN) device, the apparatus comprising means for processing one or more paging messages from one or more paging devices during a Negotiation time (NT) in a timeblock of a data group including the NAN device, a paging message of the one or more paging messages comprising an indication of at least one class type of data pending for the NAN device; and means for, based on the one or more paging messages, transmitting one or more trigger messages to the one or more paging devices during a Data Transmission Time (DTxT) following the NT, the one or more trigger messages to trigger transmission of the data pending for the NAN device.

Example 137 includes the subject matter of Example 136, and optionally, comprising means for transmitting a trigger message to trigger transmission of buffered traffic from a paging device.

Example 138 includes the subject matter of Example 136 or 137, and optionally, comprising means for transmitting a first trigger message to trigger transmission of data from a first paging device having a first priority, and, subsequent to the first trigger message, transmitting a second trigger message to trigger transmission of data from a second paging device having a second priority, which is lower than the first priority.

Example 139 includes the subject matter of any one of Examples 136-138, and optionally, comprising means for transmitting a first trigger message to trigger transmission of first data having a first priority, and, subsequent to the first trigger message, transmitting a second trigger message to trigger transmission of second data having a second priority, which is lower than the first priority.

Example 140 includes the subject matter of any one of Examples 136-139, and optionally, wherein the one or more trigger messages comprise at least one unicast trigger message to at least one respective paging device.

Example 141 includes the subject matter of any one of Examples 136-140, and optionally, comprising means for transmitting a multicast trigger message to two or more paging devices.

Example 142 includes the subject matter of Example 141, and optionally, wherein the two or more paging devices comprise devices from which paging messages indicate data of different class types is pending for the NAN device.

Example 143 includes the subject matter of Example 141, and optionally, wherein the two or more paging devices comprise devices from which paging messages indicate data of a same class type is pending for the NAN device.

Example 144 includes the subject matter of any one of Examples 136-143, and optionally, comprising means for determining one or more parameters of a contention window corresponding to the class type of the data pending for the NAN device, and contending to transmit a trigger message during the contention window, the trigger message to request transmission of the data of the class type pending for the NAN device.

Example 145 includes the subject matter of Example 144, and optionally, comprising means for determining a beginning of the contention window based on a timing of the paging message.

Example 146 includes the subject matter of Example 145, and optionally, comprising means for selecting an interval from a predefined number of intervals in the DTxT based on the timing of the paging message, and beginning the contention window at a beginning of the interval.

Example 147 includes the subject matter of Example 144, and optionally, comprising means for determining a beginning of the contention window based on a number of paging messages, which are received prior to the paging message, and which indicate a same class type as the class type of the data pending for the NAN device.

Example 148 includes the subject matter of any one of Examples 144-147, and optionally, comprising means for determining a duration of the contention window based on a priority of the class type of the data pending for the NAN device.

Example 149 includes the subject matter of any one of Examples 136-148, and optionally, wherein the paging message comprises one or more list elements corresponding to one or more class types, a list element corresponding to a class type indicating one or more devices of the data group for which data of the class type is pending transmission.

Example 150 includes the subject matter of Example 149, and optionally, wherein the one or more list elements comprise at least a multicast list element to indicate one or more devices for which multicast data is pending.

Example 151 includes the subject matter of Example 149 or 150, and optionally, wherein the one or more list elements comprise at least a unicast list element to indicate one or more devices for which unicast data is pending.

Example 152 includes the subject matter of any one of Examples 149-151, and optionally, wherein the one or more list elements comprise at least four list elements corresponding to at least four respective class types.

Example 153 includes the subject matter of Example 152, and optionally, wherein the at least four list elements comprise at least a Video (VI) list element, a Voice (VO) list element, a best Effort (BE) list element, and a Background (BK) list element.

Example 154 includes the subject matter of any one of Examples 136-153, and optionally, wherein the one or more trigger messages comprise a Quality of Service (QoS) Null frame.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-25. (canceled)

26. An apparatus comprising logic and circuitry configured to cause a Neighbor Awareness Networking (NAN) device to:
generate a paging message comprising one or more list elements corresponding to one or more class types, a list element corresponding to a class type to indicate one or more devices of a data group for which data of the class type is pending transmission;
transmit the paging message during a Negotiation time (NT) in a timeblock of the data group;
process a trigger message from a paged device of the data group during a Data Transmission Time (DTxT) following the NT; and
based on the trigger message, transmit data to the paged device during the DTxT.

27. The apparatus of claim 26, wherein the one or more list elements comprise at least a multicast list element to indicate one or more devices for which multicast data is pending.

28. The apparatus of claim 26, wherein the one or more list elements comprise at least a unicast list element to indicate one or more devices for which unicast data is pending.

29. The apparatus of claim 26 configured to cause the NAN device to include an indication of a device of the data group only in a list element corresponding to a class type of a highest priority for which data is pending transmission to the device of the data group.

30. The apparatus of claim 26, wherein the one or more list elements comprise at least four list elements corresponding to at least four respective class types.

31. The apparatus of claim 26, wherein the trigger message comprises a Quality of Service (QoS) Null frame.

32. The apparatus of claim 26 configured to cause the NAN device to determine one or more parameters of a contention window based at least on a class type of the data to be transmitted to the paged device, and to contend to transmit the data to the paged device during the contention window.

33. The apparatus of claim 26, wherein the trigger message comprises a unicast trigger message from the paged device to the NAN device.

34. The apparatus of claim 26, wherein the trigger message comprises a multicast trigger message from the paged device to a plurality of NAN devices comprising said NAN device.

35. The apparatus of claim 26 comprising a memory, a processor, and one or more antennas.

36. A product comprising one or more tangible computer-readable non-transitory storage media comprising computer-executable instructions operable to, when executed by at least one computer processor, enable the at least one computer processor to implement operations at a Neighbor Awareness Networking (NAN) device, the operations comprising:
generating a paging message comprising one or more list elements corresponding to one or more class types, a list element corresponding to a class type to indicate one or more devices of a data group for which data of the class type is pending transmission;
transmitting the paging message during a Negotiation time (NT) in a timeblock of the data group;
processing a trigger message from a paged device of the data group during a Data Transmission Time (DTxT) following the NT; and
based on the trigger message, transmitting data to the paged device during the DTxT.

37. The product of claim 36, wherein the operations comprise determining one or more parameters of a contention window based at least on a class type of the data to be transmitted to the paged device, and contending to transmit the data to the paged device during the contention window.

38. An apparatus comprising logic and circuitry configured to cause a Neighbor Awareness Networking (NAN) device to:
process one or more paging messages from one or more paging devices during a Negotiation time (NT) in a timeblock of a data group including the NAN device, a paging message of the one or more paging messages comprising an indication of at least one class type of data pending for the NAN device; and
based on the one or more paging messages, transmit one or more trigger messages to the one or more paging devices during a Data Transmission Time (DTxT) following the NT, the one or more trigger messages to trigger transmission of the data pending for the NAN device.

39. The apparatus of claim 38 configured to cause the NAN device to transmit a trigger message to trigger transmission of buffered traffic from a paging device.

40. The apparatus of claim 38 configured to cause the NAN device to transmit a first trigger message to trigger transmission of data from a first paging device having a first priority, and, subsequent to the first trigger message, to transmit a second trigger message to trigger transmission of data from a second paging device having a second priority, which is lower than the first priority.

41. The apparatus of claim 38 configured to cause the NAN device to transmit a first trigger message to trigger transmission of first data having a first priority, and, subsequent to the first trigger message, to transmit a second trigger message to trigger transmission of second data having a second priority, which is lower than the first priority.

42. The apparatus of claim 38, wherein the one or more trigger messages comprise at least one unicast trigger message to at least one respective paging device.

43. The apparatus of claim 38 configured to cause the NAN device to transmit a multicast trigger message to two or more paging devices.

44. The apparatus of claim 38 configured to cause the NAN device to determine one or more parameters of a contention window corresponding to the class type of the data pending for the NAN device, and to contend to transmit a trigger message during the contention window, the trigger message to request transmission of the data of the class type pending for the NAN device.

45. The apparatus of claim 44 configured to cause the NAN device to determine a beginning of the contention window based on a timing of the paging message.

46. The apparatus of claim 45 configured to cause the NAN device to select an interval from a predefined number of intervals in the DTxT based on the timing of the paging message, and to begin the contention window at a beginning of the interval.

47. The apparatus of claim 44 configured to cause the NAN device to determine a beginning of the contention window based on a number of paging messages, which are received prior to the paging message, and which indicate a same class type as the class type of the data pending for the NAN device.

48. The apparatus of claim 44 configured to cause the NAN device to determine a duration of the contention window based on a priority of the class type of the data pending for the NAN device.

49. A product comprising one or more tangible computer-readable non-transitory storage media comprising computer-executable instructions operable to, when executed by at least one computer processor, enable the at least one computer processor to implement operations at a Neighbor Awareness Networking (NAN) device, the operations comprising:
processing one or more paging messages from one or more paging devices during a Negotiation time (NT) in a timeblock of a data group including the NAN device, a paging message of the one or more paging messages comprising an indication of at least one class type of data pending for the NAN device; and
based on the one or more paging messages, transmitting one or more trigger messages to the one or more paging devices during a Data Transmission Time (DTxT) following the NT, the one or more trigger messages to trigger transmission of the data pending for the NAN device.

50. The product of claim 49, wherein the operations comprise determining one or more parameters of a contention window corresponding to the class type of the data pending for the NAN device, and contending to transmit a trigger message during the contention window, the trigger message to request transmission of the data of the class type pending for the NAN device.
